(19) United States
(12) Patent Application Publication
(10) Pub. No.: US 2003/0036955 A1
(43) Pub. Date: Feb. 20, 2003

(54) Advertising server, method, program and recording medium

(75) Inventors: Ritsuko Tanaka, Kawasaki (JP); Toru Tsuruta, Kawasaki (JP); Norichika Kumamoto, Kawasaki (JP); Ryuta Tanaka, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/001,992

(22) Filed: Dec. 5, 2001

(30) Foreign Application Priority Data
Aug. 16, 2001 (JP) 2001-246961

(51) Int. Cl. G06F 17/60

(52) U.S. Cl. 705/14

(57) ABSTRACT

A newspaper dealer server is provided with at least a contractor data base that registers contractors who have subscriber contracts with a newspaper dealer. An advertisement preparation unit of the server prepares an advertisement that is requested from an advertiser, and places it in an advertisement Web page. Upon finding that a user is a contractor on the contractor data base through an input of the user information, an advertisement utilization unit of the server publicizes the advertisement Web page and allows the user to view it.

### BACKGROUND OF THE INVENTION

1. Field of the Invention

The present invention relates to advertising server, method, program and recording medium for establishing an advertising system of a local area contacting type that allows people to visit an advertisement by utilizing the Internet, and more particularly concerns such advertising server, method program and recording medium which supply advertisements to subscribers by a server of a newspaper dealer.

2. Description of the Related Art

FIGS. 1A and 1B show conventional advertising systems that utilize a newspaper dealer. Normally, each newspaper dealer 200 is placed at each predetermined area that is comparatively limited area in which each newspaper dealer 200 is capable of delivering newspapers, and closely contacts the corresponding local society. The advertisement, carried out by the newspaper dealer 200, is an inserted-bill advertisement in which hand bills are inserted in newspapers and delivered. An advertiser 204, such as a retail outlet, within a business area of a newspaper dealer 200 prepares an advertisement or requests an advertisement preparation agent 206 to prepare an advertisement, through a paper-printing method, and requests the newspaper dealer 200 to deliver the advertisement as inserted bills. The newspaper dealer 200 sorts requested advertisements in a sorting section 212, and inserts requested bills in an inserting section 214 by manual operations or machine operations. In the case of the machine operations, a predetermined number of bills are placed in the machine, and after confirming by a confirmation section 216 that the bills have been properly dealt with, another set of bills are again placed in the machine; thus, these operations are repeated so as to carry out the bill-inserting operation to newspaper. Upon completion of the operation, newspaper delivery persons deliver newspapers having inserted-bills to respective contractors 208.

Moreover, in recent years, with respect to an advertising system of a local area contacting type utilizing the Internet, the Internet inserted-bill supplying service, “Orikomio!®”, which allows the user to view advertisements, etc. of a desired area by allowing the user to input the postal code of the corresponding area, has started in a limited area (http://www.dnp-orikomio.com/CGI/pilot/home.cgi). In this system, advertisements and recruitment information that have been registered by advertisers such as retail outlets with the payment of advertising fees are placed on the Web pages for three days so that general users and registered users are allowed to view desired pages for free of charge, and this system is expected as an advertising system of the local area contacting type.

However, in the present Internet inserted-bill supplying service, all the managing costs of the Web pages and the advertising fees have to be paid by advertisers, resulting in high advertisement coverage costs. Moreover, conventionally, it has been an established custom that information such as advertisements of local retail outlets is given by inserted bills in newspapers; therefore, demands are not so strong for advertisers to try to use the Internet inserted-bill service with the payment of additional advertising fees. For this reason, in an attempt to newly start the Internet inserted-bill service, it is necessary to use considerable work loads, time and costs so as to form a network by newly making contracts with local retail outlets, etc., and expanding the users, and it is difficult to get business prospects as to whether or not the system can be managed with profits. Moreover, in the case when the Internet inserted-bill service comes to cover a wide area such as the Kansai area, large-scale advertisers carry advertisements aiming at all areas specified by postal codes; therefore, on the Web page in the same area, inserted-bill advertisements of a local retail outlet and a large-scale advertiser are carried side by side at the same time. In this situation, the inherent objective of the inserted-bill advertisement for supplying life information closely contacting the corresponding local area is impaired, and it is highly possible that the Internet inserted-bill service by local retailer outlets, etc. might fail without being widely used.

### SUMMARY OF THE INVENTION

In accordance with the present invention, it is possible to provide advertising server, method, program and recording medium that can positively achieve an advertising system of a local area contacting type utilizing, for example, the Internet and properly manage the system.

Moreover, the present invention pays attention to an existing advertising system using newspaper inserted bills that are dealt by newspaper dealers, and provides advertising server, method, program and recording medium for newspaper dealers, which positively establish an advertising system of a local area contacting type by utilizing the Internet, and successfully carry out the system.

The advertising server of the present invention is characterized by including: a data base which registers a supplier for providing a first service and users that have contracts with the supplier, an advertisement preparation unit for preparing an advertisement requested by an advertiser and for placing it on a Web page so as to be viewed, that is, for providing a second service, and an advertisement utilization unit which, in the case when a user is identified as a contractor user of the first service on the data base through the inputted user information, allows the user to view the advertisement on the Web page so as to provide the second service. In particular, the advertising server of the present invention is characterized by including, at least, a contractor data base that registers contractors that have subscriber contracts (first service) with the newspaper dealer, an advertisement preparation unit for preparing an advertisement requested by an advertiser (second service) and for placing it on a Web page so as to be viewed, and an advertisement utilization unit which, in the case when a user is identified as a contractor user on the data base through the inputted user information, allows the user to view the advertisement on the Web page.

In this manner, in the present invention, a newspaper dealer utilizes the advertising server so as to establish an advertising system utilizing the Internet for advertisers that deal with the newspaper dealer and subscribers of the newspaper, that is, supplies the second service for allowing the user to view advertisements by utilizing the Internet on the premise of the first service that the user is a subscriber of the newspaper; therefore, it is possible to positively establish an advertising system of a local area contacting type with the advertisers and the users being specified, in a short period, and also to successfully carry out the system. Moreover, the costs required for managing the advertising server basically depend on advertising fees from the advertisers, while the users who are also subscribers of the newspaper pay for one portion of the costs as subscription fees; thus, one portion of the subscription fees can be allocated to the management of the system as the number of subscribers increases through the management of the advertising system. Moreover, a delivery area of each newspaper dealer is determined based upon physical distances and time, etc., and even in the case of an advertising system utilizing the Internet, advertisers who request inserted-bill advertisements are limited to the delivery area or on the periphery thereof, while advertisements aiming at larger areas are originally supplied as newspaper advertisements; thus, it is possible to properly inherit the advantages of the conventional inserted-bill advertisements that closely contact to a specific local area, that is, easiness, local property and cheapness of advertising costs. Moreover, in the present invention, the Web pages on which advertisements are placed are only viewed by the contractor users who are registered in the data base of the newspaper dealer, on principle, and only the users who are also subscribers of the newspaper are allowed to view the advertisements placed by the server of the newspaper dealer. The limitation of users of this type is derived from the fact that the advertising service is carried out on the premise of newspaper subscriptions; this results in a discriminated state to non-subscribers of the newspaper. This discriminated state makes it possible to increase new subscribers of the newspaper. The present invention is basically distinct from the conventional system, such as “Orikomio!®”, which depends all the advertising costs on the advertisers with all the users being free of charge in that only the limited contractor users that are newspaper subscribers are allowed to view the advertisements, and this makes it possible to positively establish an advertising system utilizing the Internet that closely contact to a local area, and also to successfully carry out the system.

Here, the advertisement preparation unit of the advertising server inputs an electronic medium advertisement from an advertiser and places it on a Web page, and also converts a paper-medium advertisement from an advertiser to electronic data, and place it on a Web page. Moreover, the advertisement preparation unit can also prepare an advertisement requested from an advertiser or a Web page of an advertiser. This electronic-medium advertisement includes not only still images, but also those advertisements using motion pictures and voice. When a user visits an advertisement on the Web page, an advertisement utilization unit of the advertising server gives a user privileges offered by the newspaper dealer and the advertiser. In this manner, when the user visits an advertisement, he or she can receive those privileges, such as discount services and point services, offered by the newspaper dealer and the advertiser; thus, it is possible to enhance the advertising effect of the advertiser. The advertisement utilization unit of the advertising server stores advertisement selection information specified and desired by a user, and delivers an advertisement corresponding to the corresponding advertisement selection information by mail or facsimile. For this reason, by preliminarily specifying selection information for desired advertisements such as newly arrival information and genre of advertisements in the server, the user is allowed to obtain desired advertisements through mail or facsimile without accessing the server. Based upon the linking request specified by a user, the advertisement utilization unit of the advertising server makes a link to the publicized Web page of the advertiser. This arrangement allows the user to know the details of the advertiser and make a proper judgment on the contents of the advertisement. Moreover, the advertiser is allowed to change and add information to the contents of the advertisement with respect to the link specified by the user, without the necessity of a request to the newspaper dealer. Based upon a linking request specified by a user, the advertisement utilization unit makes an access to a Web page of the advertiser managed by a newspaper dealer on the same chain in a different area. This arrangement makes it possible to get advertisement information in a different area, if necessary. The advertisement utilization unit of the advertising server automatically edits a Web page exclusively used by the user based upon the advertisement selection information specified by the user and stores the resulting data, or downloads the data to the user device. In this manner, the advertising page, automatically edited by the specification of the user, is downloaded from the server to a user device or a client device, for example, to a mobile terminal; thus, the user makes it possible to visit the advertisement page of the mobile terminal any time, later when he or she goes shopping, etc. The advertisement utilization unit of the advertiser stores the advertisement selection information specified by the user, and upon receiving a visiting request from the user, automatically edits the Web page dedicated to the user based upon the stored advertisement selection information, and allows the user to visit the page. Thus, by specifying a necessary genre, etc., the user is allowed to establish an advertising page dedicated to himself or herself on the server, and to view the resulting page. The advertisement preparation unit of the advertising server places local information other than advertisements, such as bulletin boards and link collections on the Web page, and the advertisement utilization unit publicizes the local information to the contractor users and non-contract users of the data base. In this manner, by utilizing the advantages of the area-contacting type system, the present invention makes it possible to place not only advertisements, but also local information such as bulletin boards carrying public information of the area and link collections of public organizations; thus, it is also utilized as the information window of the local society. This local information is publicized not only to the contractor users, but also to non-contract users, thereby allowing wider utilization. Upon receipt of a visiting request from a non-contractor user not registered in the data base, the advertisement utilization unit of the advertising server presents an application page for the newspaper subscriber. This arrangement makes it possible to expect new contracts for newspaper subscribers with respect to non-contract users who wish to visit the advertisement visiting service, and to increase the customers. Moreover, the advertisement utilization unit of the advertising server retrieves contractor users who need to update the contract from the data base, and displays the necessity of updating the contract at the time of visiting the page. This arrangement reduces the necessity of visiting the users' home to update the contract, and also provides a smooth updating process at the time of visiting the user's home, by preliminarily informing the users of the necessity of updating. Based upon a request for preparation of a guide map including the current position specified by a user and the destination indicating the advertiser, the advertisement utilization unit of the advertising server prepares the guide map indicating a route from the current position to the destination, and publicizes it in the Web page, or allows the user device to download it. Thus, it becomes possible to positively guide the user through the map even if he or she does not know the location of the advertiser, and consequently to reduce time-consuming tasks of the advertiser to deal with inquiries for the location. The advertisement utilization unit of the advertising server transmits an ordering request for an advertised commodity from a user to the advertiser's device as ordering information, and after the transmission, manages processes from the delivery to the receipt of the ordered commodity. With this arrangement, the user is allowed to receive the ordered commodity at the newspaper dealer, or to ask the newspaper dealer to deliver the commodity; thus, this allows the newspaper dealer to start a new business, that is, a commodity delivering business. In particular, since the newspaper delivery person is quite familiar with the local area, he or she can positively deliver the ordered commodity quickly together with the delivery of the newspaper. Based upon the request from the user, the advertisement utilization unit of the advertising server prints an advertisement placed on a Web page on paper media, and distributes the resulting advertisement. Thus, it is possible for the user to receive a necessary advertisement as an inserted bill by means of paper medium, in the same manner as the conventional advertisement. The advertisement utilization unit of the advertising server registers visiting information of the user for each advertisement visit, surveys the advertisement utilization state by retrieving the data base after a lapse of a predetermined period from the publish of the advertisement, and informs the advertiser's device of the results of the survey, and determines and settles the advertisement publishing fee based upon the results of the survey. Upon receipt of a feedback of the results of the survey, the advertiser is allowed to confirm the effects of the advertisement so as to utilize them for the next advertisement coverage and business strategy, etc. Moreover, the newspaper dealer may take a charging system in which, in the case when the results of the survey show that sufficient advertising effects have been obtained, it can ask the advertiser to pay an additional advertising fee based upon the successful advertisement.

The present invention provides an advertising method using a server. This advertising method is characterized by including:

a registering step of registering in a data base a supplier for supplying a first service and users having contracts with the supplier;

an advertisement preparation step of preparing an advertisement requested from the advertiser and of placing the advertisement in a Web page to allow it to be viewed, which is a second service;

an advertisement utilization step in which, in the case when a user is identified as a contractor user of the first service on the data base through the inputted user information, the user is allowed to view the advertisement on the Web page so as to provide the second service. In particular, the present invention, which supplies an advertising method using a server as a newspaper dealer, is characterized by executing:

a registering step of registering at least contractors having subscriber contracts with a newspaper dealer in a data base;

an advertisement preparation step of preparing an advertisement requested by an advertiser and of placing it in a Web page; and

an advertisement utilization step in which, in the case when a user is identified as a contractor user of the first service on the data base through the inputted user information, the user is allowed to view the advertisement on the Web page so as to provide the second service. The contents of this advertising method are basically the same as the advertising server.

The present invention provides a program that is executed by a computer for carrying out an advertising service using the Internet. This program is characterized by allowing a computer functioning as a server to execute:

a registering step of registering in a data base a supplier for supplying a first service and users having contracts with the supplier;

an advertisement preparation step of preparing an advertisement requested from the advertiser and of placing the advertisement in a Web page to allow it to be viewed, which is a second service; and

an advertisement utilization step in which, in the case when a user is identified as a contractor user of the first service on the data base through the inputted user information, the user is allowed to view the advertisement on the Web page so as to provide the second service. In particular, the program of the present invention is characterized by allowing a computer functioning as a server of a newspaper dealer to execute:

a registering step of registering at least contractors having subscriber contracts with a newspaper dealer in a data base;

an advertisement preparation step of preparing an advertisement requested by an advertiser and of placing it in a Web page; and

an advertisement utilization step in which, in the case when a user is identified as a contractor user of the first service on the data base through the inputted user information, the user is allowed to view the advertisement on the Web page. The contents of this program are basically the same as the advertising server.

The present invention provides a recording medium that can be read by a computer and that stores a program to be executed by the computer for providing an advertising service utilizing the Internet. The program, stored in this recording medium, is allowed to execute:

a registering step of registering in a data base a supplier for supplying a first service and users having contracts with the supplier;

an advertisement preparation step of preparing an advertisement requested from the advertiser and of placing the advertisement in a Web page to allow it to be viewed, which is a second service; and

an advertisement utilization step in which, in the case when a user is identified as a contractor user of the first service on the data base through the inputted user information, the user is allowed to view the advertisement on the Web page so as to provide the second service. In particular, a program stored in the recording medium of the present invention allows a computer functioning as a server of a newspaper dealer to execute:

a registering step of registering at least contractors having subscriber contracts with a newspaper dealer in a data base;

an advertisement preparation step of preparing an advertisement requested by an advertiser and of placing it in a Web page; and

an advertisement utilization step in which, in the case when a user is identified as a contractor user on the data base through the inputted user information, the user is allowed to view the advertisement on the Web page. The contents of this recording medium are basically the same as the advertising server.

The above and other objects, features and advantages of the present invention will become more apparent from the following detailed description with reference to the drawings.

### BRIEF DESCRIPTION OF THE DRAWINGS

FIGS. 1A and 1B are explanatory drawings that show a conventional advertising system utilizing an inserted-bill advertisement in a newspaper dealer;

FIGS. 2A and 2B are block diagrams that show advertising systems utilizing a sales network of a newspaper dealer in accordance with the present invention;

FIG. 3 is an explanatory drawing that shows a contractor data base in FIGS. 2A and 2B;

FIG. 4 is an explanatory drawing that shows a user data base in FIGS. 2A and 2B;

FIG. 5 is a flow chart that schematically shows processes carried out by a server of a newspaper dealer in FIGS. 2A and 2B;

FIG. 6 is a flow chart showing an advertisement preparation process of FIG. 5;

FIGS. 7A and 7B are explanatory drawings that show system functions of the advertisement preparation process of FIG. 6;

FIG. 8 is a flow chart showing an advertisement preparation process of FIG. 5;

FIGS. 9A and 9B are explanatory drawings that show system functions of a contractor user determining process in FIG. 8;

FIGS. 10A and 10B are explanatory drawings that show a user information input screen for a user client in FIGS. 9A and 9B and a screen given in the case when determined as a non-contractor user;

FIGS. 11A-11D are flow charts that show the contractor utilization process in FIG. 8;

FIGS. 12A and 12B are explanatory drawings that show advertisement publishing screens of step S1 of FIG. 11A;

FIGS. 13A and 13B are explanatory drawings that show privileges given at steps S3 and S4;

FIGS. 14A and 14B are explanatory drawings that show a function of an advertiser computer executed when privileges are given at steps S3 and S4;

FIGS. 15A and 15B are explanatory drawings that show an advertisement delivering process by steps S5 to S7 of FIG. 11A;

FIGS. 16A and 16B are explanatory drawings that show an advertisement selection screen for clients used for delivering an advertisement, and selection specification and mail delivery;

FIGS. 17A and 17B are explanatory drawings that show advertiser links used in steps S8 and S9 in FIG. 11A;

FIGS. 18A and 18B are explanatory drawings that show wide area links used in steps S10 and S11 of FIG. 11B;

FIGS. 19A and 19B are explanatory drawings that show an advertisement automatic editing process and a downloading process executed in steps S12 to S17 in FIG. 11B;

FIGS. 20A and 20B are explanatory drawings that show a selection screen and an editing screen in the advertisement automatic editing process;

FIGS. 21A and 21B are explanatory drawings that show another embodiments of an advertisement automatic editing process;

FIG. 22 is an explanatory drawing that shows a local information viewing process executed by steps S18 and S19 of FIG. 11B;

FIG. 23 is an explanatory drawing that shows a local information viewing screen;

FIGS. 24A and 24B are explanatory drawings that explain preparation of a guide map in steps S20 to S22 in FIG. 11C;

FIG. 25 is an explanatory drawing that shows an input specifying screen for the preparation of a guide map and a guide map screen thus prepared;

FIGS. 26A and 26B are explanatory drawings that show ordering process of a commodity in steps S23 and S24 of FIG. 11C;

FIGS. 27A and 27B are explanatory drawings that show a delivering process of a paper-medium advertisement in steps S25 and S26 of FIG. 11C;

FIG. 28 is a flow chart that shows a non-contractor utilization process of FIG. 8 in detail;

FIGS. 29A, 29B are explanatory drawings that show an application page for newspaper subscription;

FIG. 30 is an explanatory drawing that shows an application process for a newspaper subscription;

FIG. 31 is a flow chart that shows an advertisement survey process in FIG. 5;

FIGS. 32A and 32B are explanatory drawings that show system functions of the advertisement survey process; and

FIGS. 33A to 33C are flow charts that show a processing system for the advertisement survey.

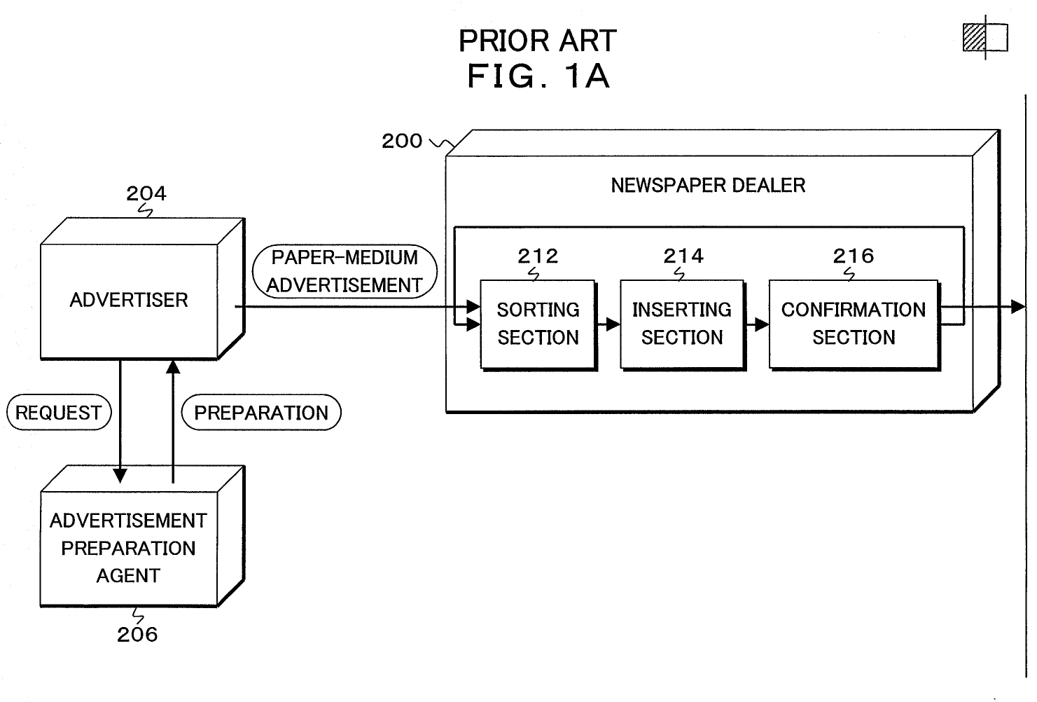

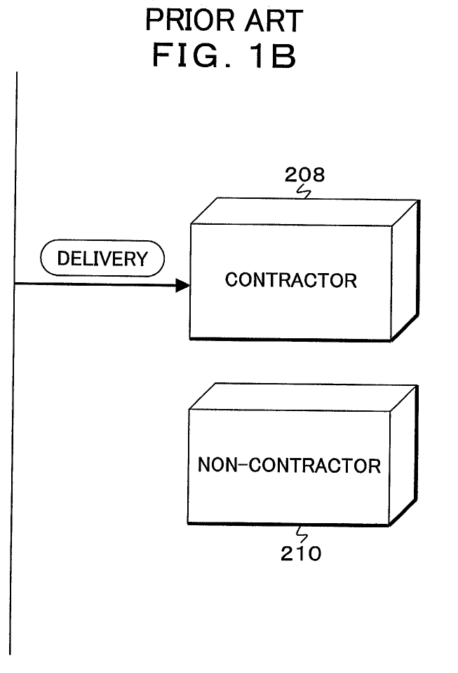

### DETAILED DESCRIPTION OF THE PREFERRED EMBODIMENT

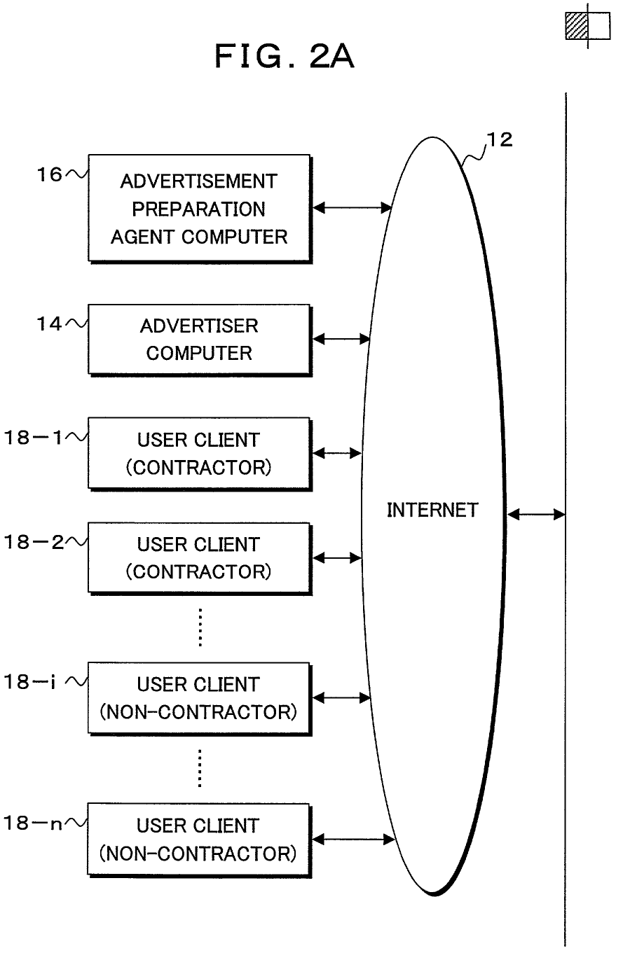

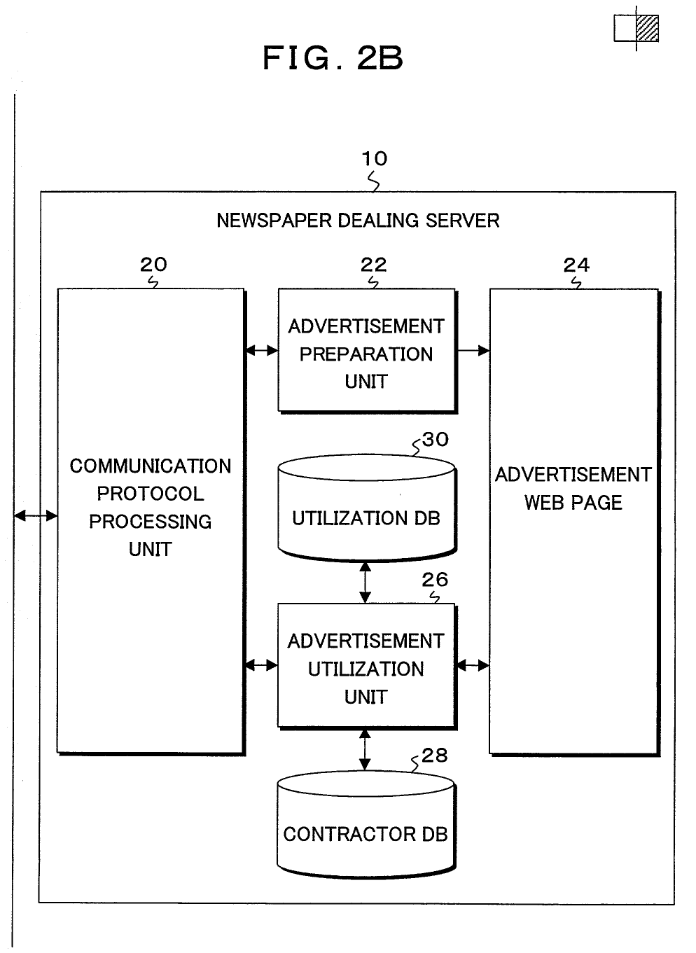

FIGS. 2A and 2B are block diagrams that show system constructions of an advertising system utilizing a newspaper dealer in accordance with the present invention. The advertising system of the present invention includes a newspaper dealer server (advertising server) 10 placed in a newspaper dealer, an advertiser computer 14 placed in an advertiser, an advertisement preparation agent computer 16 placed in an advertisement preparation agent and user clients 18-1, 18-2, . . . 18-n possessed by contractors of newspaper subscription or non-contractors, and these devices are connected through the Internet 12. The newspaper dealer server 10 is provided with a communication protocol processing unit 20, an advertisement preparation unit 22, an advertisement Web page 24, an advertisement utilization unit 26, a contractor data base 28 and a user data base 30. The advertising system of the present invention is arranged so that only contractor for subscription with a newspaper dealer is allowed to access a Web page 24 supplied by the newspaper dealer server 10. In other words, the newspaper dealer daily delivers newspapers to the contractors based upon the newspaper subscription contract, and these subscription contractors are contractor users of the advertisement Web page 24 in the newspaper dealer server 10 of the advertising system in accordance with the present invention, and these contractor users are registered in the contractor data base 28. For this reason, upon establishing the advertising system of the present invention, the contractor data base 28 is formed based upon a list of contractors for newspaper subscription that is possessed by a newspaper dealer, and registered by the server.

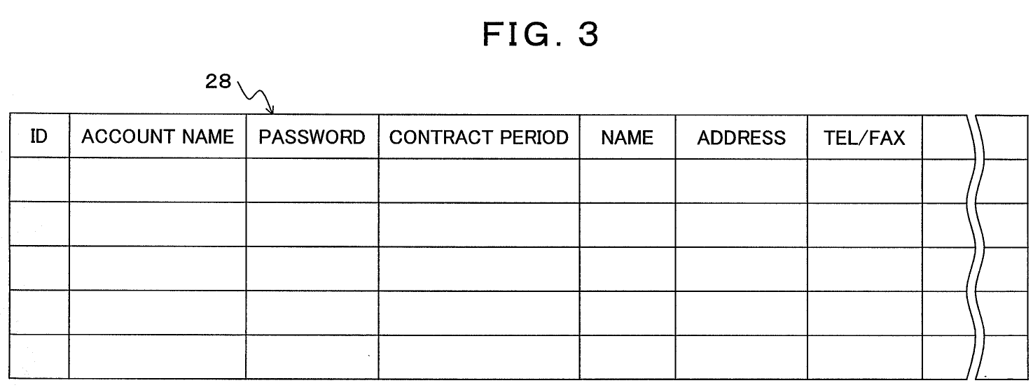

FIG. 3 is one example showing the contractor data base 28 of FIGS. 2A and 2B. In the contractor data base 28, in addition to an ID, an account name and a password for allowing the contractor to access an advertisement Web page 24 are registered. Successively, attribute information for a user, such as a contract term of newspaper subscription the name, address, telephone number and facsimile number of the user, is registered, if necessary.

Referring again to FIGS. 2A and 2B, the advertisement preparation unit 22 prepares an electronic medium advertisement based upon a request from an advertiser, and places the resulting advertisement in an advertisement Web page 24. This electronic medium advertisement includes multi-media such as still images, motion picture images and voice. The advertisement utilization unit 26 refers to utilization information derived from an access from each of user clients 18-1 to 18-n, and in the case when the user is identified as a contractor on the contractor data base 28, publicizes the advertisement of the advertising Web page 24 so as to allow him or her to view the page. A utilization data base 30 is connected to the advertisement utilization unit 26 so as to register information of the utilization state of the advertisement Web page 24 by users, for example, the number of visits of the advertisement.

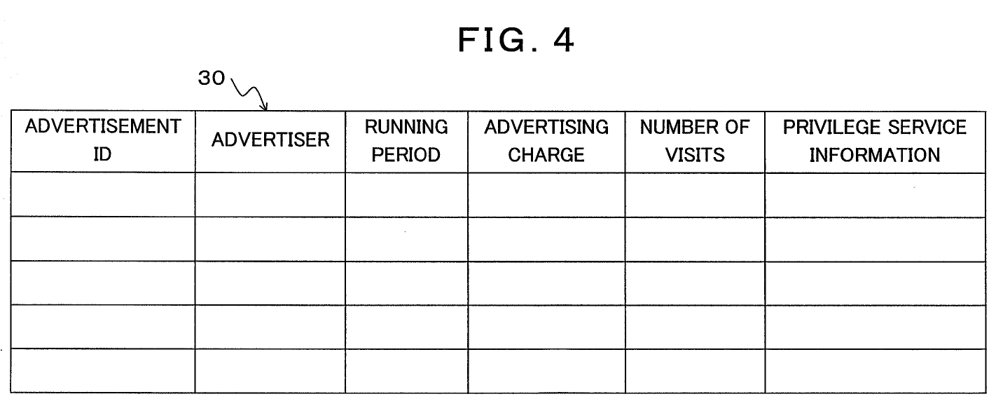

FIG. 4 shows one example of the utilization data base 30 of FIGS. 2A and 2B. In accordance with an advertisement ID attached to each electronic medium advertisement of the advertisement Web page 24, the utilization data base 30 registers an advertiser, an advertising period and an advertising fee, and also registers the number of visits by users and privilege utilization information such as discount services and point services given by newspaper dealers or advertisers as privilege for advertisement viewers. This utilization data base 30 is used for the survey on the advertisement utilization state by the advertisement utilization unit 24, which will be described later.

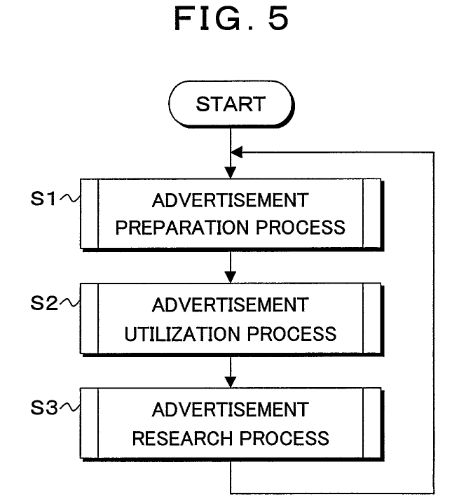

FIG. 5 is a flow chart that schematically shows a process carried out by the newspaper dealer server 10 of FIGS. 2A and 2B. The newspaper dealer server 10 carries out an advertisement preparation process at step S1, an advertisement utilization process at step S2, and an advertisement survey process at step S3; thus, these processes are repeated therein.

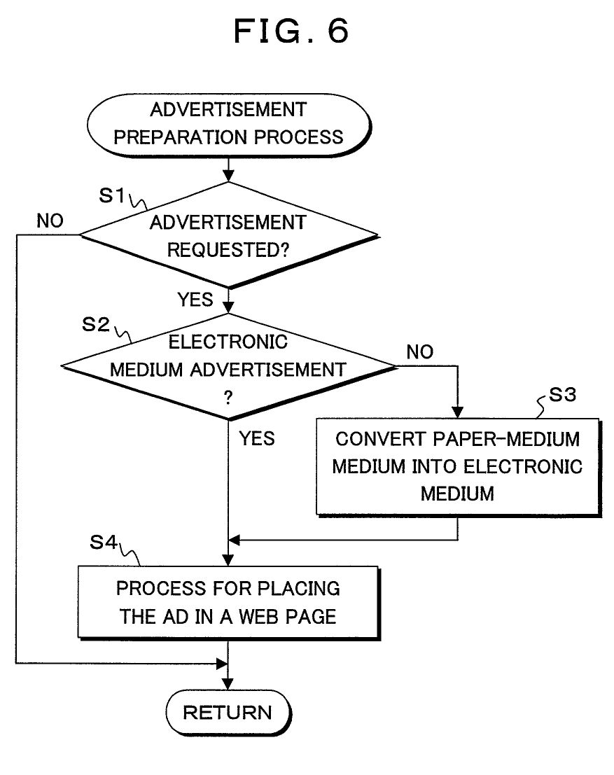

FIG. 6 shows the advertisement preparation process at step S1 in FIG. 5 in detail. The advertisement preparation process receives an advertisement application from an advertiser at step S1. Successively, at step S2, a check is made as to whether or not the advertisement that has been applied for is an electronic medium advertisement. If it is an electronic medium advertisement, it is subjected to a Web page placement process at step S4. If it is not an electronic medium advertisement, but a paper-medium advertisement, the paper-medium advertisement is converted to an electronic advertisement at step S3, and then subjected to the Web page placement process at step S4.

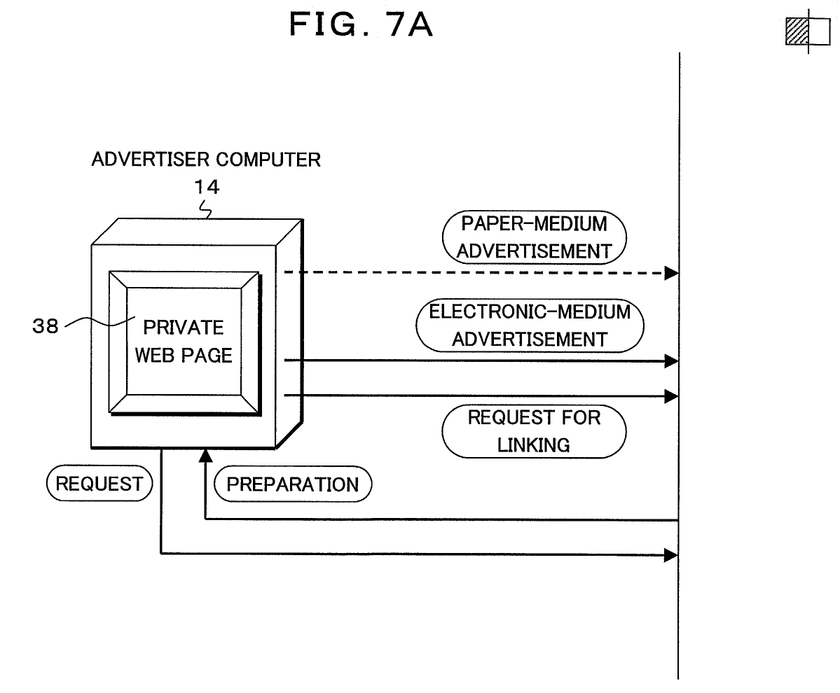

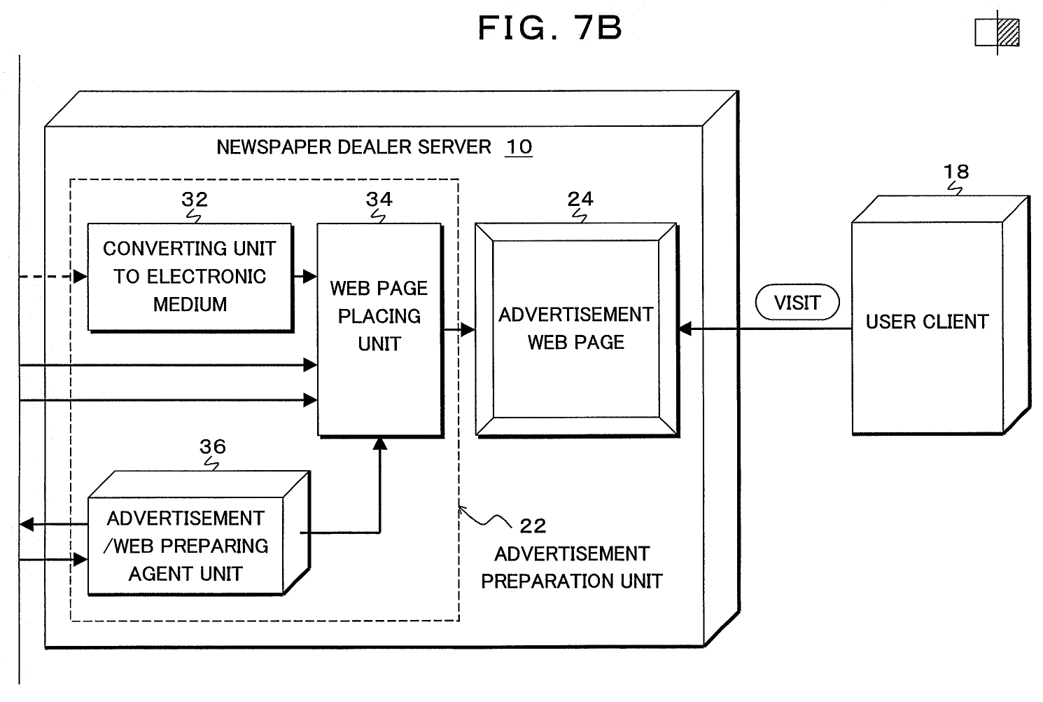

FIGS. 7A and 7B are explanatory drawings that show system functions corresponding to the advertisement preparation process of FIG. 6. The newspaper dealer server 10 includes, as functions for the advertisement preparation unit 22, a converting unit to electronic medium 32, a Web page placing unit 34 and an advertisement/Web preparing agent unit 36. In the case when an electronic medium advertisement is prepared based upon the advertisement application, the advertiser computer 14 of an advertiser accesses the newspaper dealer server 10 to place the electronic medium advertisement in the advertisement Web page 24 through the Web page placing unit 34 of the advertisement preparation unit 24. Moreover, in the case when the advertiser applies for advertisement through a paper-medium advertisement, the converting unit to electronic medium 32, installed in the advertisement preparation unit 24 of the newspaper dealer server 10 in the newspaper dealer, converts the paper-medium advertisement to an electronic medium advertisement, and places this in the Web page 24 by the Web page placing unit 32. Furthermore, the advertisement preparation unit 24 of the newspaper dealer server is provided with an advertisement/Web preparing agent unit 36. Upon receiving, for example, an advertisement application from an advertiser, the advertisement/Web preparing agent unit 36 prepares an electronic-medium advertisement of the advertiser within the server in accordance with the contents of the application, and places this in an advertisement Web page 24 through the Web page placing unit 34. Moreover, the advertisement/Web preparing agent unit 36 receives a preparation request of a private Web page 38 from an advertiser, and in this case also, it sends a prepared Web page to the advertiser computer 14, thereby placing it as a private Web page 38.

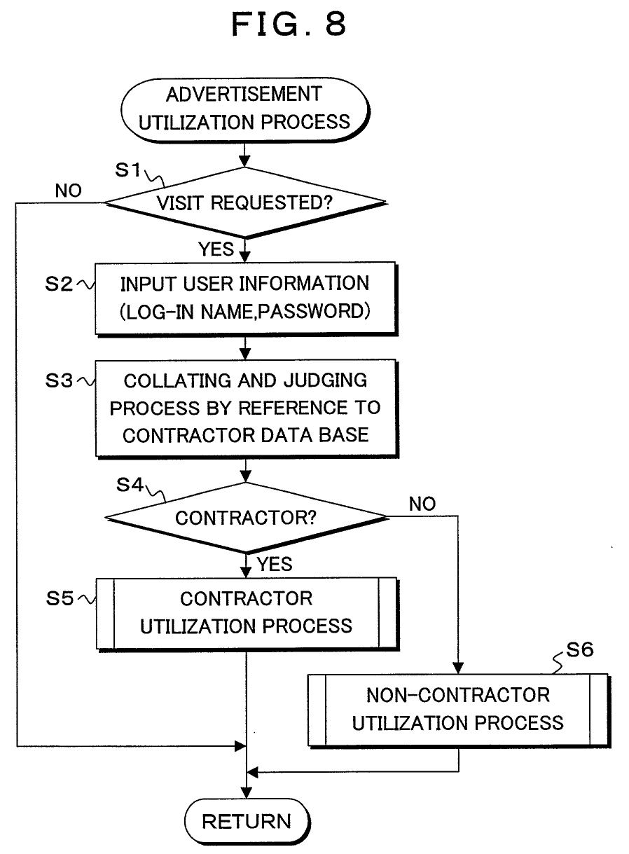

FIG. 8 is a flow chart of an advertisement utilization process in the newspaper dealer server 10 at step S2 of FIG. 5. This advertisement utilization process is executed by an advertisement utilization unit 26 installed in the newspaper dealer server 10 of FIGS. 2A and 2B. When a visiting request is received from a user client at step S1, the user information is inputted at step S2. This user information is constituted by a log-in name and a password. Successively, at step S3, the contractor data base 28 is referred to based upon the log-in name and the password at step S3; thus, the log-in name and password are collated and identified. When the user is determined as one of the contractors at step S4, the contractor utilization process of step S5 is executed. In contrast, in the case when the user is not a contractor, the non-contractor utilization process of step S6 is executed.

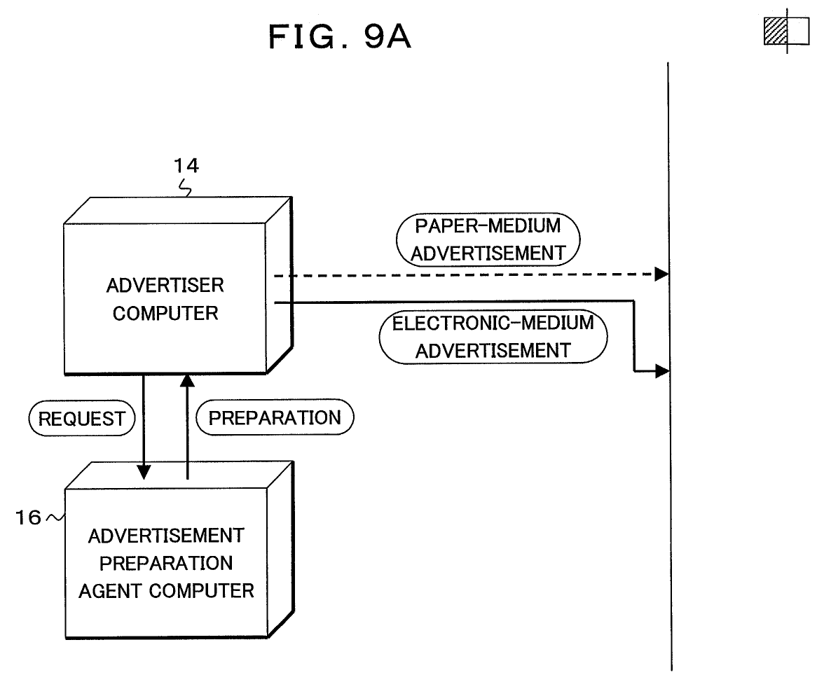

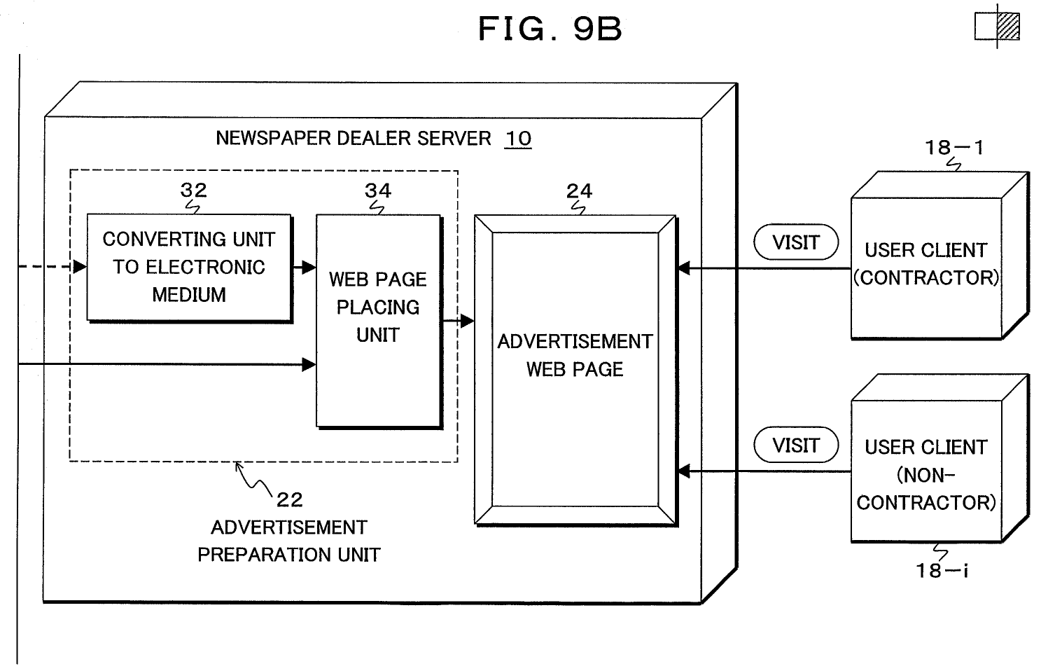

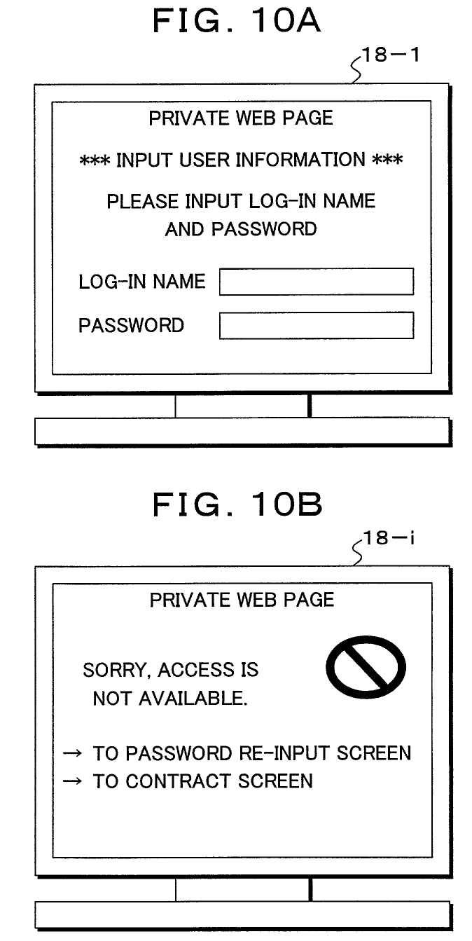

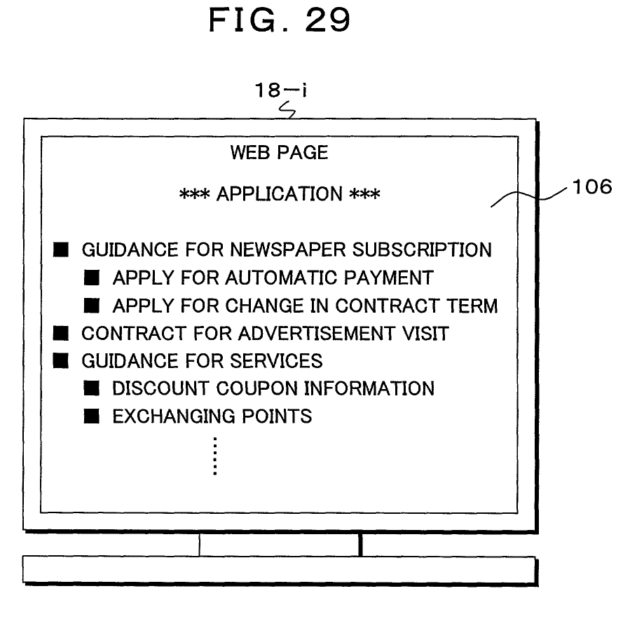

FIGS. 9A and 9B are explanatory drawings that show system functions in the advertisement utilization process of FIG. 8. Not only the user client 18-1, but also the user client 18-i who is a non-contractor is allowed to access the newspaper dealer server 10 through the Internet. Upon receipt of such an access from the user client 18-1 or 18-i, the newspaper dealer server 10 first supplies a password input screen 40 as shown in FIG. 10A to the client device. The password input screen 40 requests inputs of a log-in name and a password. Thus, in the case of a contractor who has preliminarily received a log-in name and a password, he or she inputs the log-in name and the password, and sends these to the newspaper dealer server 10 as user information. In contrast, in the case of a non-contractor who has neither log-in name nor password, when he or she sends the password input screen 40 without inputting any appropriate information therein or without inputting anything, the screen switches to a message screen 42 for the non-contractor user as shown in FIG. 10B. This message screen 42 shows a re-input operation for returning to the password input screen 40 of FIG. 10A so as to deal with an access failure to the advertisement Web page or an input error by the contractor user, and a switching operation to a contract application screen for encouraging the non-contractor user to make a subscriber contract. This contract application screen is provided as a screen shown in FIG. 29, which will be described later.

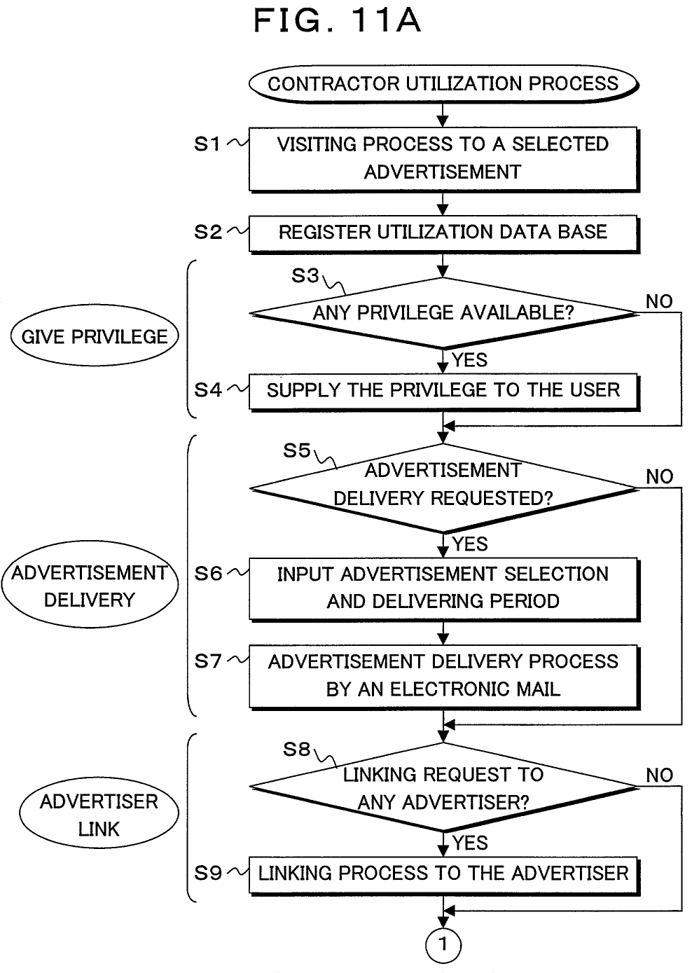

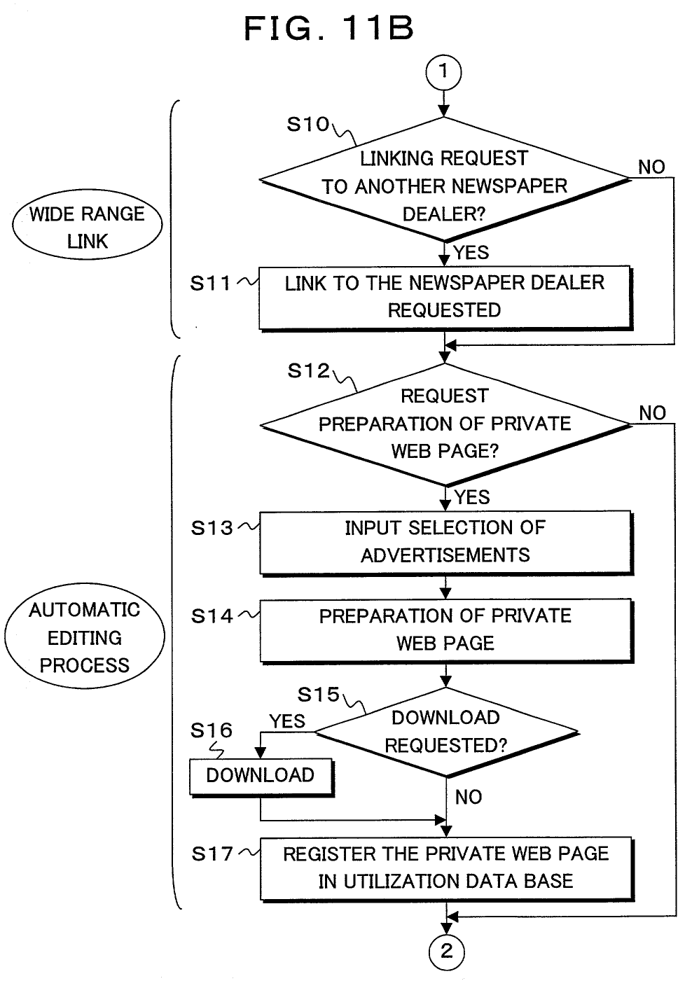

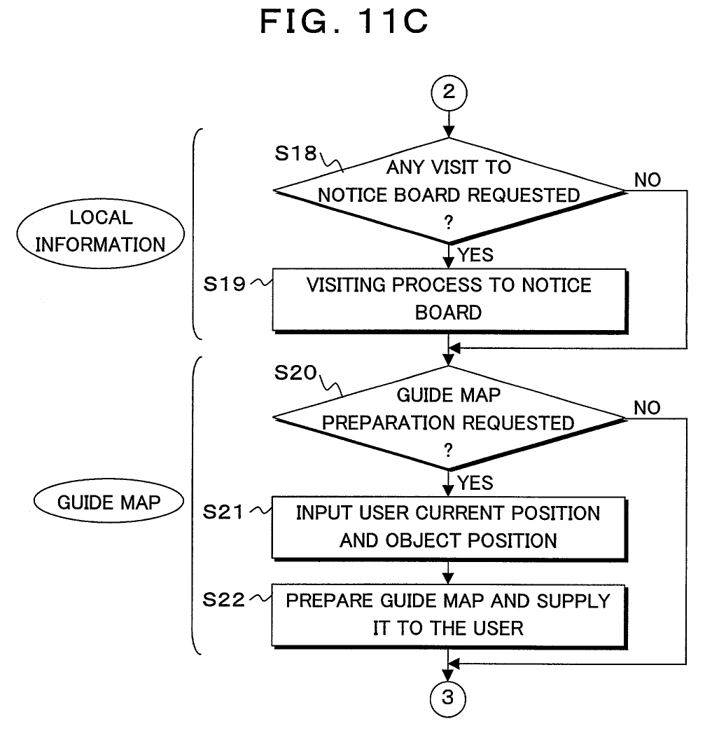

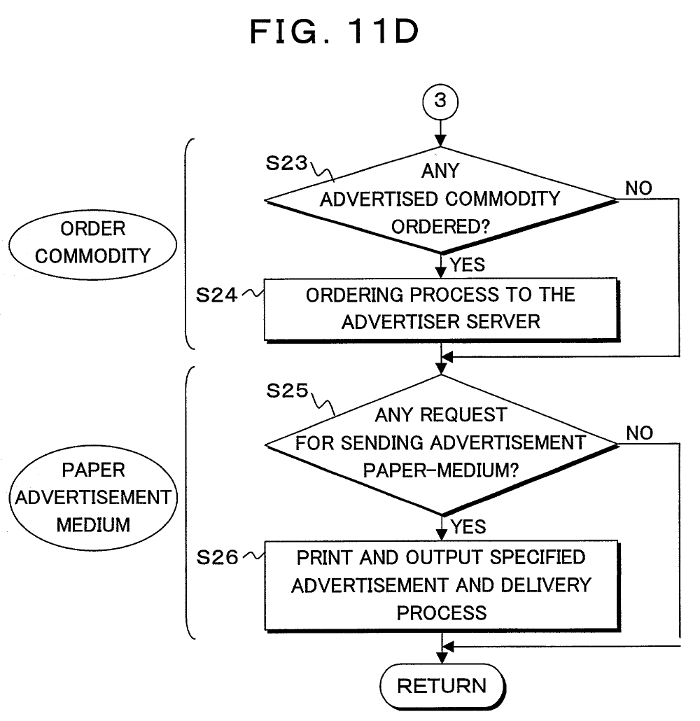

FIGS. 11A to 11D give flow charts that show the contractor utilization process at step S5 of FIG. 8 in detail. The contractor utilization process carried out by the advertisement utilization unit 26 installed in the newspaper dealer server 10 of the present invention provides the following items:

Advertisement viewing step

Privilege offering step

Advertisement delivering step

Advertiser linking step

Wide range linking step

Automatic editing step for user advertisement

Local area information

Preparation for guide maps

Ordering commodities

Delivery of paper-medium advertisement

The following description will discuss each of the items of the contractor utilization process in accordance with the present invention:

(Advertisement Viewing Step)

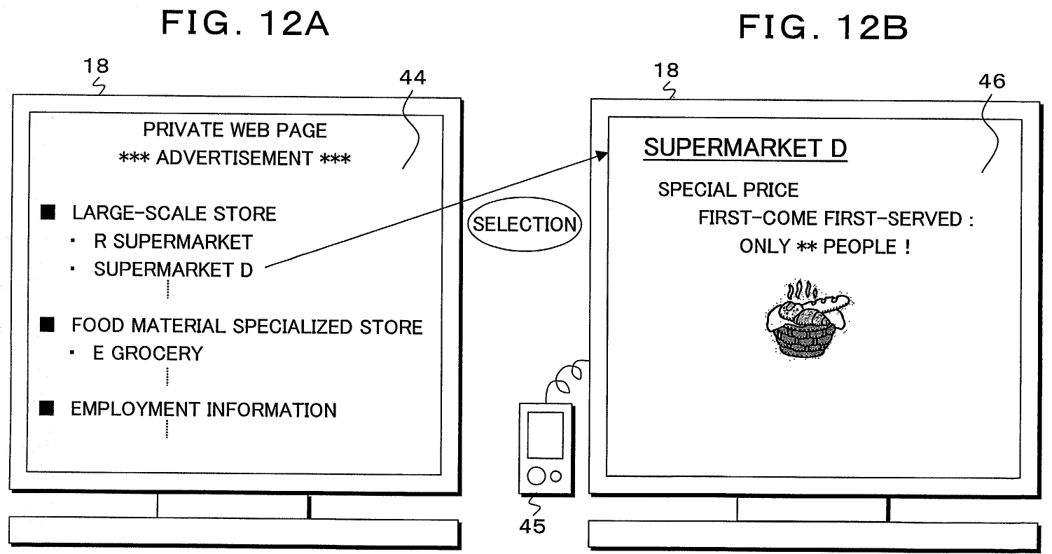

Step S1 of FIG. 11A is a viewing process of an advertisement selected by an access of a contractor user. As illustrated in FIG. 12A, this advertisement viewing step first provides a menu 44 of an advertisement Web page in the newspaper dealer server 10 to the user client 18. When, upon viewing the advertisement menu screen 44, the user selects, for example, “Supermarket D”, an advertisement screen 46 of the advertiser “Supermarket D” of FIG. 12B is displayed on the user client 18. In this example, voice guidance is also provided by a speaker 45 simultaneously. Referring again to FIG. 11A, after carrying out the advertisement viewing process in the user client selected in step S1, successively at step S2, a registration to the utilization data base is carried out so as to count up the number of visits corresponding to the advertisement thus visited in the utilization data base 30 shown in FIG. 4.

(Privilege Offering Step)

Steps S3 and S4 of FIG. 11A show privilege offering step for a user viewing the advertisement. With respect to the advertisement selected by the user at step S1, a check is made at step S3 as to whether or not any privilege is offered. If there is any privilege to be offered, the privilege is provided to the user at step S4.

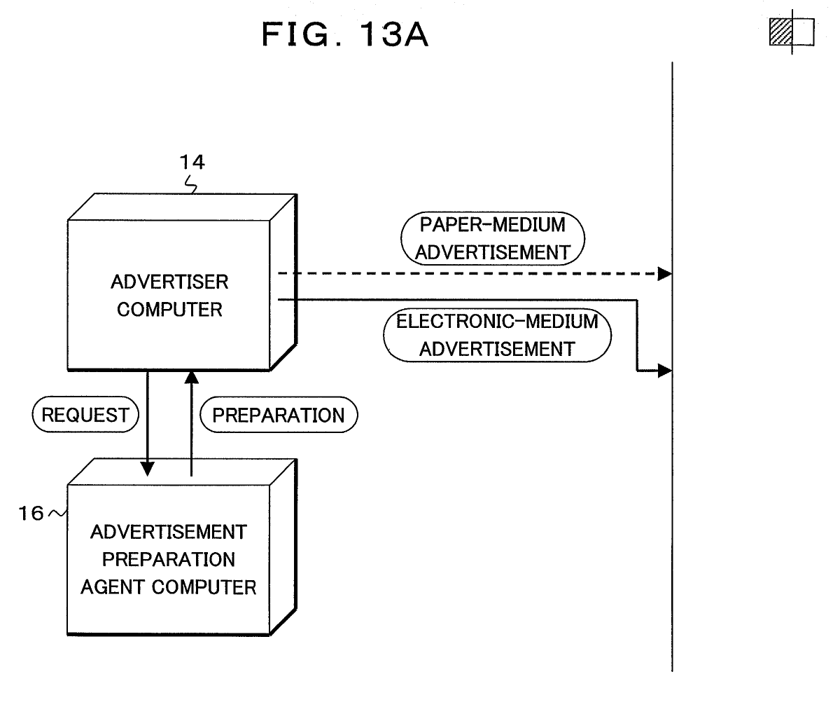

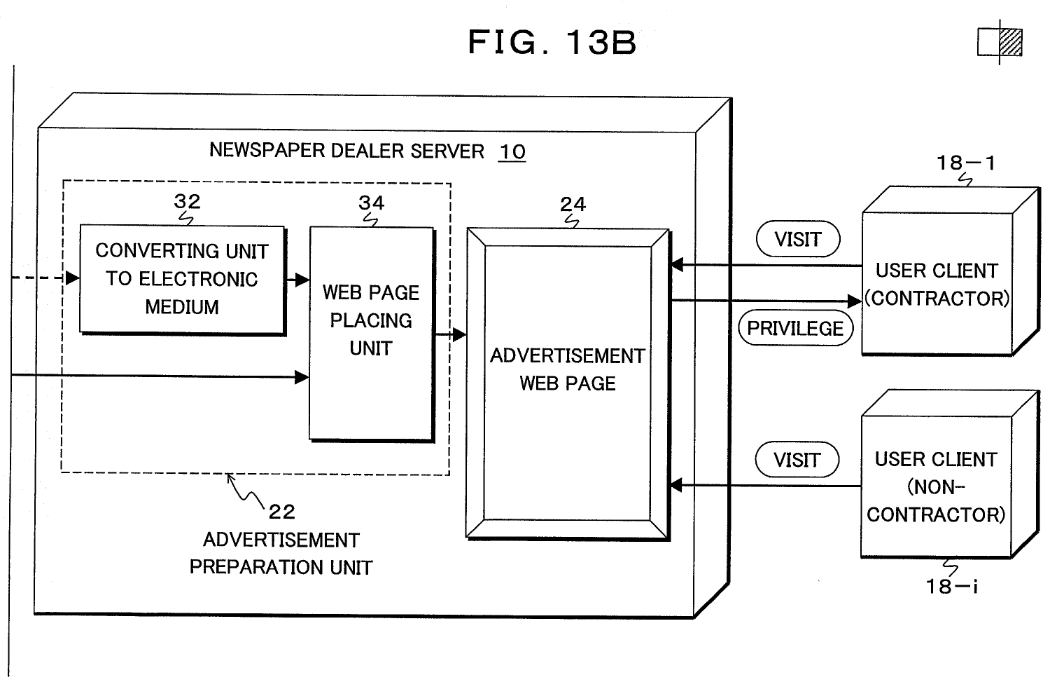

FIGS. 13A and 13B are explanatory drawings that show system functions of the privilege offering process to the user. When a contractor views an advertisement Web page 24 of the newspaper server 10 through the user client 18-1, he or she is allowed to receive the privilege set with respect to the advertisement thus viewed. Privileges to be given to the user for his or her visit to the advertisement include discount service and point service offered by the newspaper dealer or the advertiser.

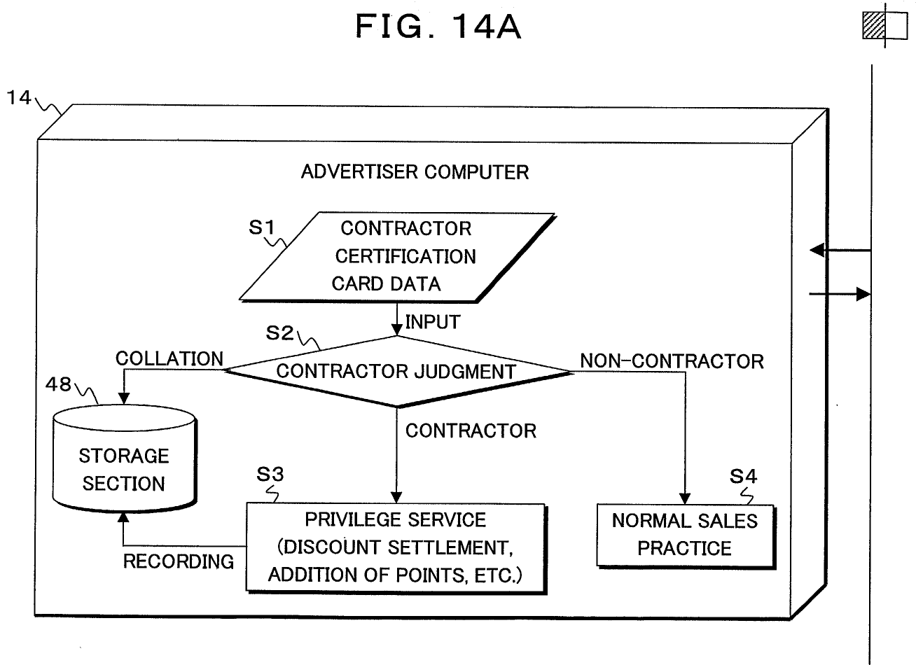

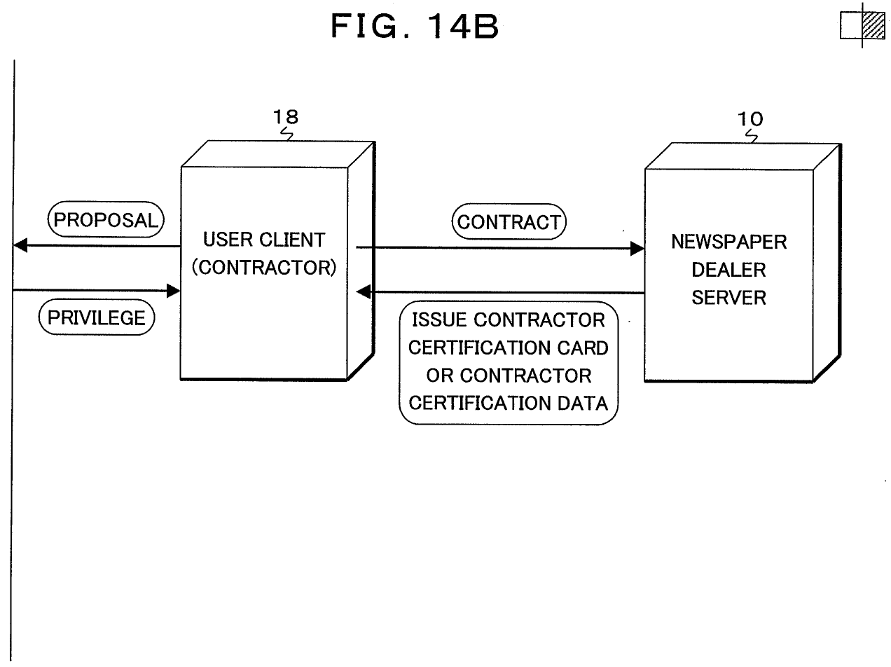

FIGS. 14A and 14B show examples of the privilege offering process to the user by an advertiser. In this privilege offering process, in order to allow the user to identify that he or she is a contractor, the newspaper dealer server 10 issues a certification card for identification having a built-in IC, or allows the mobile terminal, etc. of the contractor to download contractor certification data for contractor identification. A readable and writable dedicated memory area is allocated to this contractor certification data. In the user client 18, upon receipt of a discount service or a point service in viewing an advertisement in the newspaper dealer server 10, this service is downloaded to the contractor certification card or the contractor certification data, and this is presented to the advertiser computer 14 of the advertiser; thus, the user is allowed to receive the corresponding privilege service. In the advertiser computer 14, at step S1, the contractor certification card or the contractor certification data is inputted, and at step S2, a check is made as to whether or not the user is one of the contractors by accessing the memory unit 48. The memory unit 48 may have the same contents as those of the contractor data base 28 installed in the newspaper dealer server 10 of FIGS. 2A and 2B, or may make an inquiry to the newspaper dealer server 10 as to the contractor determination, without the data of the contractor data base. If the user is identified as a contractor through the contractor determination at step S2, a privilege offering process, such as discounted settlements or addition of points, is carried out at step S3. If, not a contractor, that is, in the case of a non-contractor, normal business practices are carried out at step S4. Moreover, the contents of the privilege offered at step S3 are stored in a storage unit 48, and the contents of the privilege offered are transferred to the newspaper dealer server 10, if necessary, and stored in the utilization data base 30 as privilege utilization information, as shown in FIG. 4.

(Advertisement Delivering Step)

Steps S5 to S7 of FIG. 11A show processes for delivering a published advertisement through electronic mail or facsimile based upon the advertisement selection information specified by the user. Upon finding a request for an advertisement delivery from a user at step S5, the sequence proceeds to step S6 where the user inputs selected information and a period of delivery of the specified advertisement, and at step S7, based upon the selected information and the period of delivery, an advertisement delivering process of the published advertisement is executed to the user client through electronic mail or facsimile.

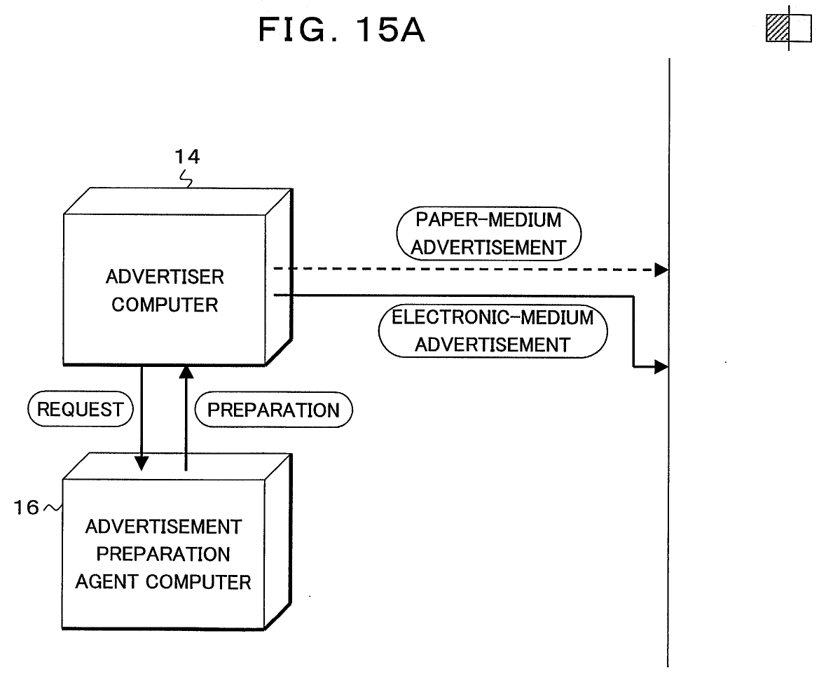

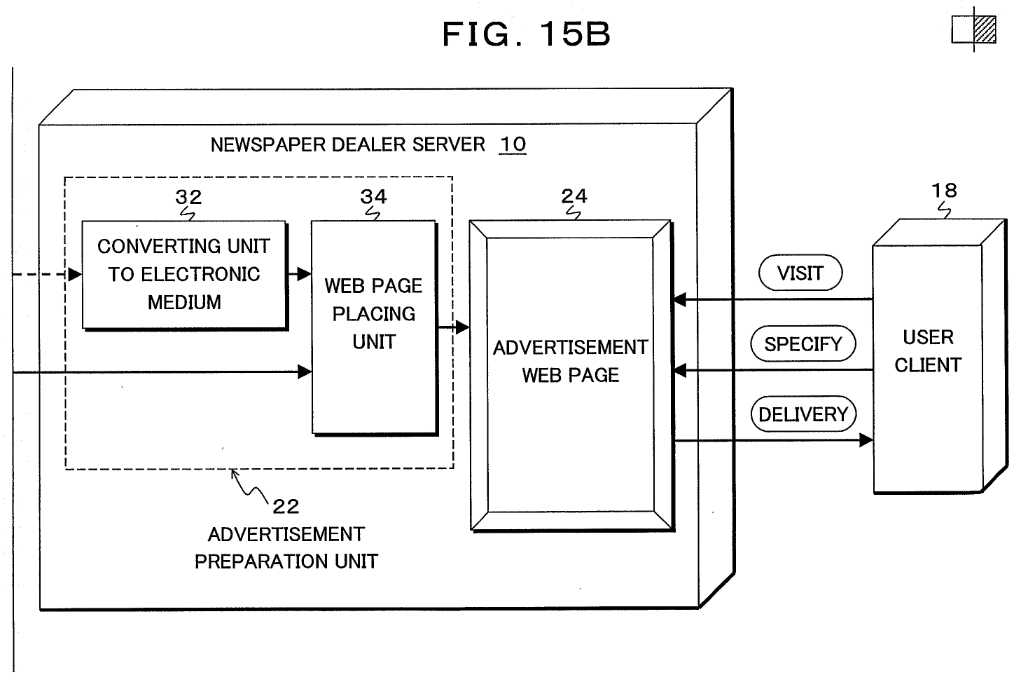

FIGS. 15A and 15B are explanatory drawings that show system functions of an advertisement delivering process. The user client 18 specifies advertisement selection information and a delivery period when viewing an advertisement Web page 24 of the newspaper dealer server 10, and upon receipt of this, the newspaper dealer server 10 automatically delivers the advertisement of advertisement Web page 24 in accordance with the specified selection information to the user client 18 through mail or facsimile.

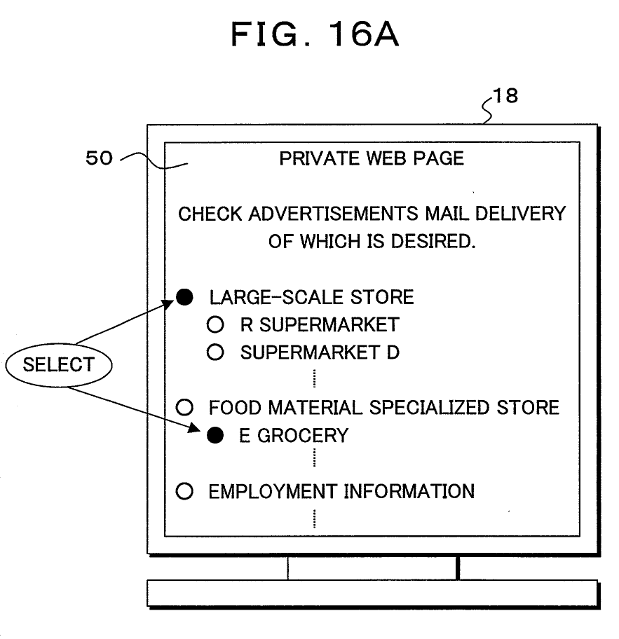

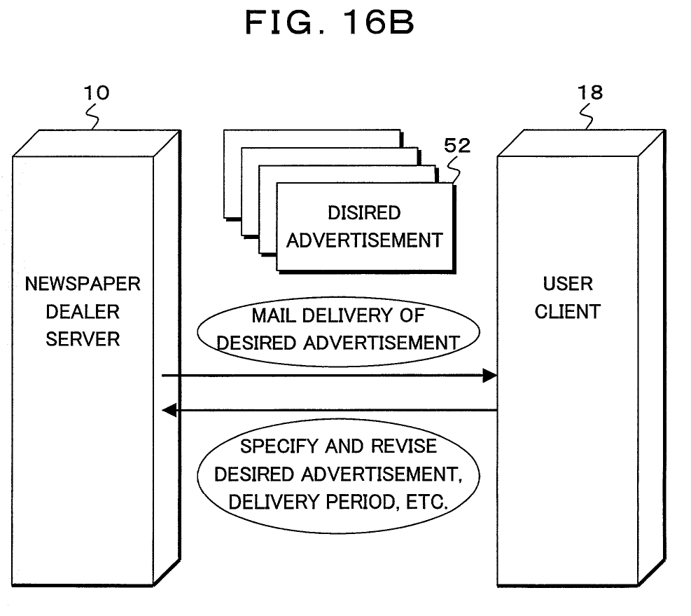

FIG. 16A shows an advertisement delivery selection screen 50 displayed on the client 18, and upon viewing this selection screen, a user selects his or her desired advertisement, for example, “large-scale store” or “E grocery shop”. Simultaneously as this selection of the desired advertisement, a desired gap of mail delivery, such as every new issue and every week, is selected as the delivery period. Moreover, not only the delivery of advertisement itself, but also only the delivery of advertisement updating information, can be carried out.

Based upon the advertisement selection information by the user, the newspaper dealer server 10 mail-delivers a desired advertisement 52 to the user client 18 that has made the corresponding application in accordance with specified contents as shown in FIG. 16B. Moreover, in the middle of a mail delivery, the user client 18 can revise the desired advertisement and delivery gap. As described above, by preliminarily placing a request for an advertisement delivery, the user can automatically receive a desired advertisement through electronic mail or facsimile without the necessity of accessing the newspaper dealer server 10; thus, it becomes possible to effectively utilize the electronic-medium advertisement placed by the newspaper dealer. Moreover, such specified information of a desired advertisement made by a user is effectively used upon collecting user information as to what advertisement or commodity the user desires carried out by the newspaper dealer and the advertiser; thus, the utilization state of the advertisement delivery is registered in the utilization data base 30 based upon the advertisement selection information by the user so that the resulting data can be effectively utilized in surveying the advertising effects for the advertiser.

(Advertiser Linking Step)

Steps S8 and S9 of FIG. 11A show a linking process to a Web page of an advertiser carried out by a user. At step S8, upon receipt of a linking request to an advertiser by the user so as to view an advertisement Web page, a linking process to the advertiser is carried out at step S9.

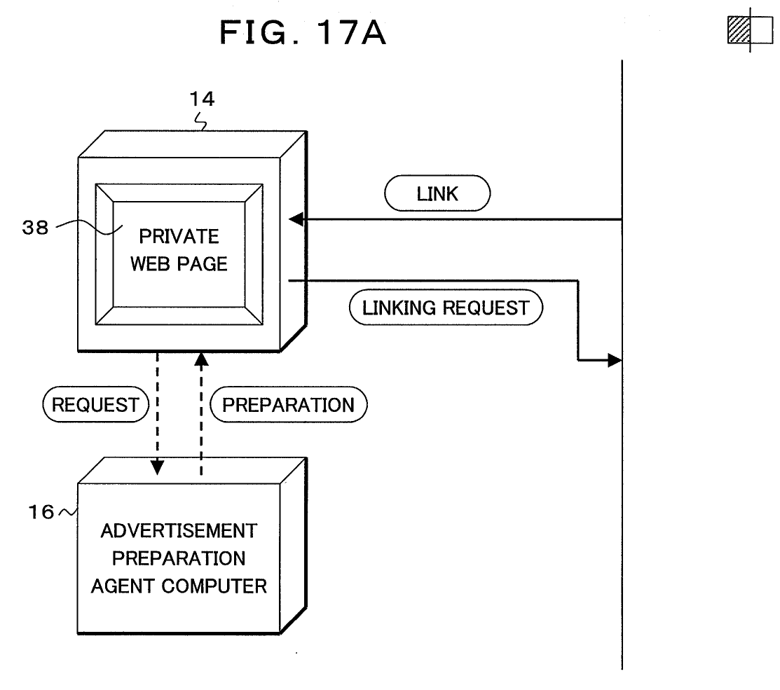

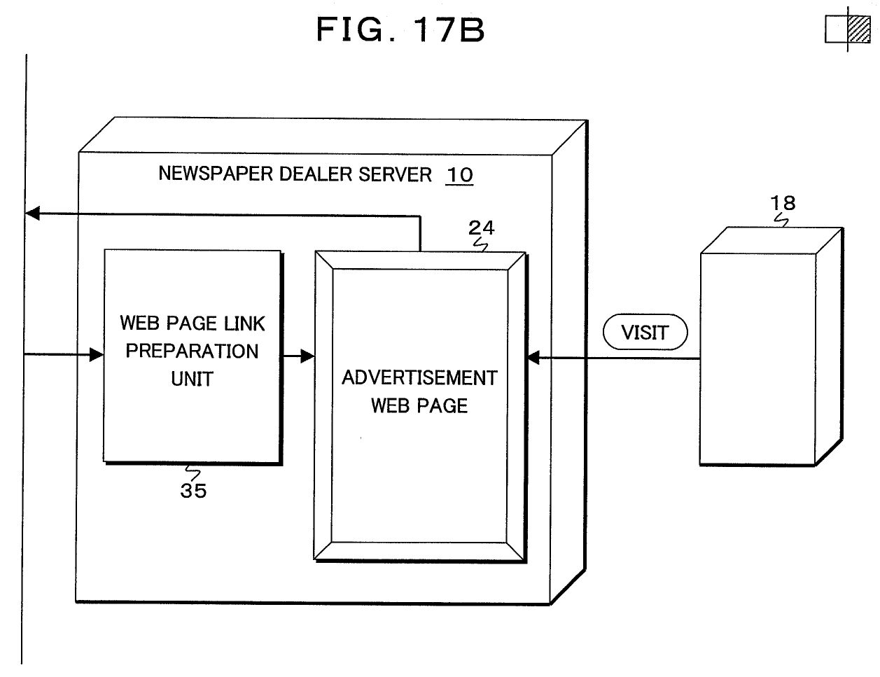

FIGS. 17A and 17B are explanatory drawings that show system functions of this advertiser linking process. The advertiser computer 14 publicizes a private Web page 30, and with respect to this private Web page 38, a Web page link preparation unit 35 is installed on the newspaper dealer server 10 so that link information to the private Web page 38 of the advertiser is set on the advertisement Web page 24. By selecting the linking information to the advertiser upon viewing the advertisement Web page 24 of the newspaper dealer server 10, the user client 18 selects the linking information of the advertiser so that it is allowed to link to the private Web page 38 of the advertiser computer 14 via the newspaper dealer server 10, and to view the page. Thus, in the case when, upon viewing the advertisement Web page 24 of the newspaper dealer server 10, the user further wants to know the detailed contents about the advertiser, he or she can visit the Web page 38 of the advertiser by selecting the link thereto, and obtain detailed information about the advertiser.

(Wide Range Linking Step)

Steps S10 and S11 of FIG. 11B show a wide range linking process that allows a user to link to another newspaper dealer server belonging to the same chain to view the advertisement placed therein, via the newspaper server dealer that the user has a contract with. In this wide range linking process, upon finding a linking request to another newspaper dealer at step S10, the user is allowed to link to the requested newspaper dealer server at step S1 to view the desired advertisement Web page.

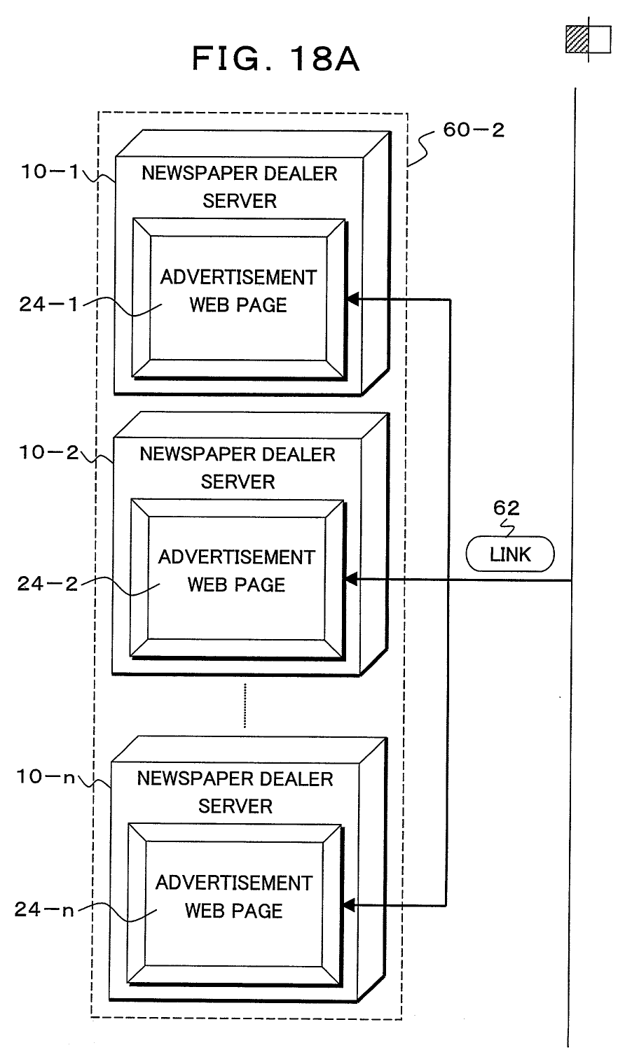

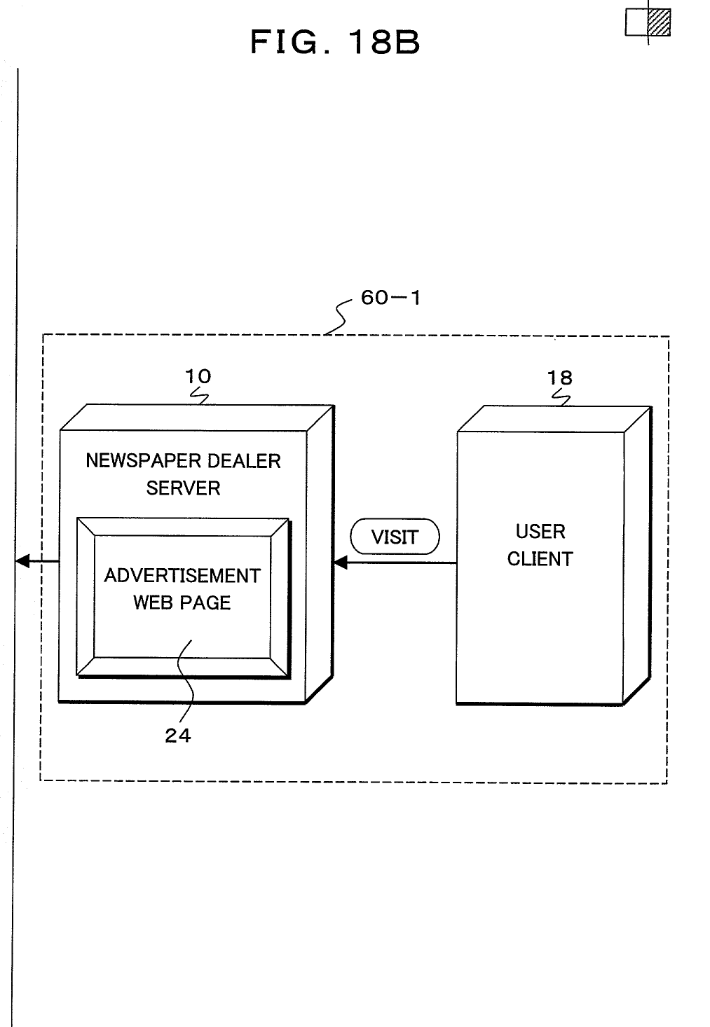

FIGS. 18A and 18B are explanatory drawings that show system functions of the wide range linking process between newspaper dealers. For example, in the case when a user client 18 views an advertisement Web page 24 of a newspaper dealer server 10 in an area 60-1, since this advertisement Web page 24 contains linking information for newspaper dealers in another area, the user is allowed to select this information. In this manner, the newspaper dealer server 10 of the area 60-1 has a link 62 attached thereto that connects to advertisement Web pages 24-1 to 24-n of newspaper dealer servers 10-1 to 10-n of another area 60-2; thus, through this link 62, the user from the user client 18 of the area 60-1 is allowed to freely view advertisement Web pages 24-1 to 24-n of the newspaper dealer servers 10-1 to 10-n in another area 62-2. Consequently, although the advertising system of the present invention has a local area contacting type system structure related to a newspaper dealer and its subscription contractors, it allows to obtain advertisement information in different areas through links to other newspaper dealer servers in the same chain, if necessary, thereby making it possible to view advertisement Web pages in a wider area. However, with respect to mutual links between the newspaper dealer servers of the present invention, the user client 18 in the area 60-1 is not necessarily forced to directly link to, for example, the newspaper dealer server 10-1 in the area 60-2, and the link 62 to another newspaper sealer server is attached thereto only as an additional service following the viewing process of the advertisement Web page 24 of the newspaper dealer server 10. For this reason, different from a normal Internet visiting process, even in the case when the linking information is found, it is not possible to provide such an arrangement in which the next access is directly made to the linking end. Thus, it is possible to continuously maintain the local area contacting type advertising system including a newspaper dealer and its contractors, in the advertising system of the present invention.

(Automatic Editing Step for User Advertisement)

Steps S12 to S17 of FIG. 11B are characterized in that, in the advertisement utilization unit 26 of the newspaper dealer server 10, an advertisement Web page dedicated to a user is prepared by an automatic editing process based upon advertisement selection information specified by a user, and in that this page is stored on the server side or downloaded to the user and the client. In this automatic editing process of a user advertisement, upon finding a preparation request for a private Web page at step S12, an input of advertisement selection information by a user is received at step S13, and a Web page dedicated to the user is prepared through an automatic editing process at step S14. Successively, in the case when the user desires to download at step S14, the private Web page is downloaded to the user client at step S16. In the case when the user does not desire to download the private Web page, the private Web page is stored in the utilization data base 30 at step S17.

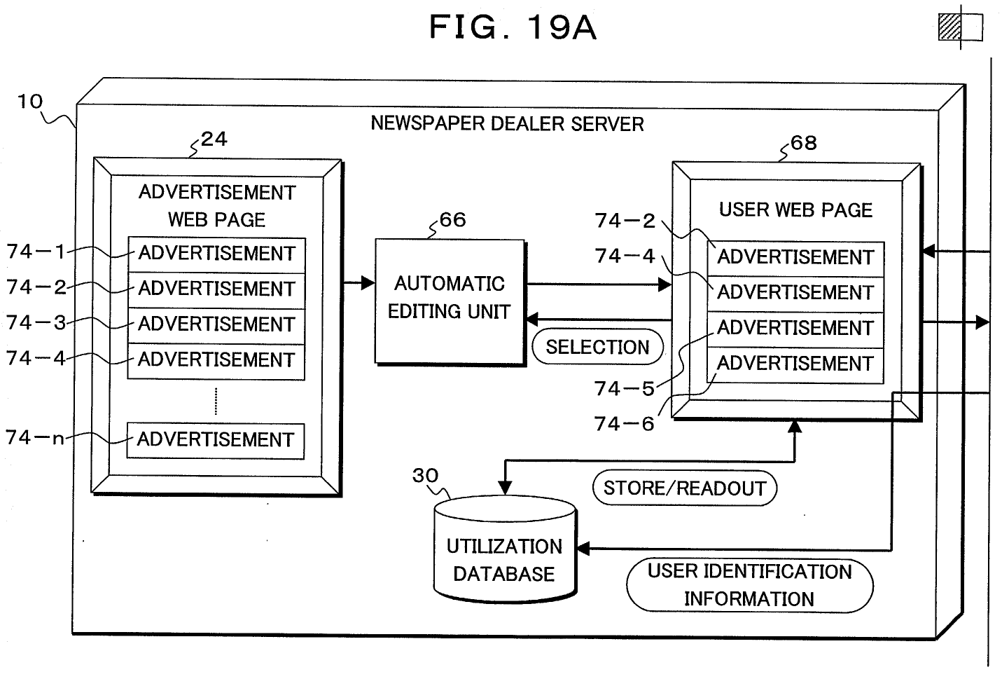

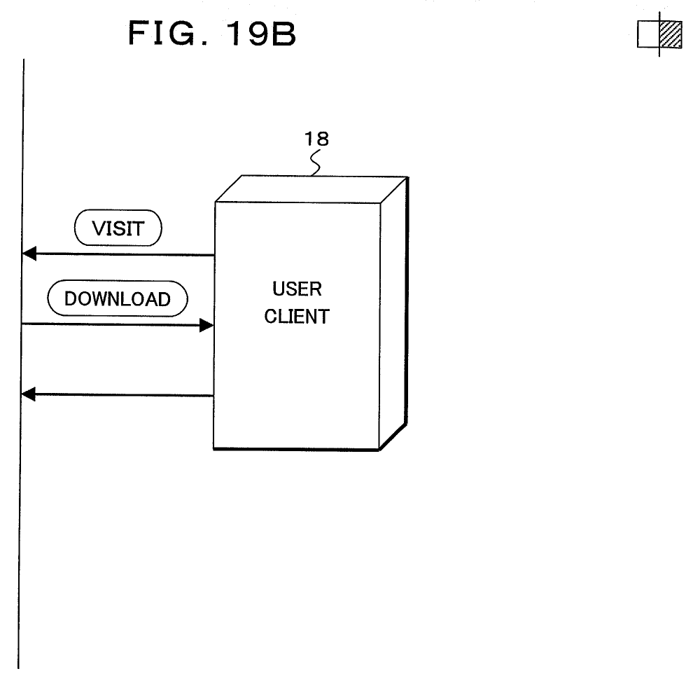

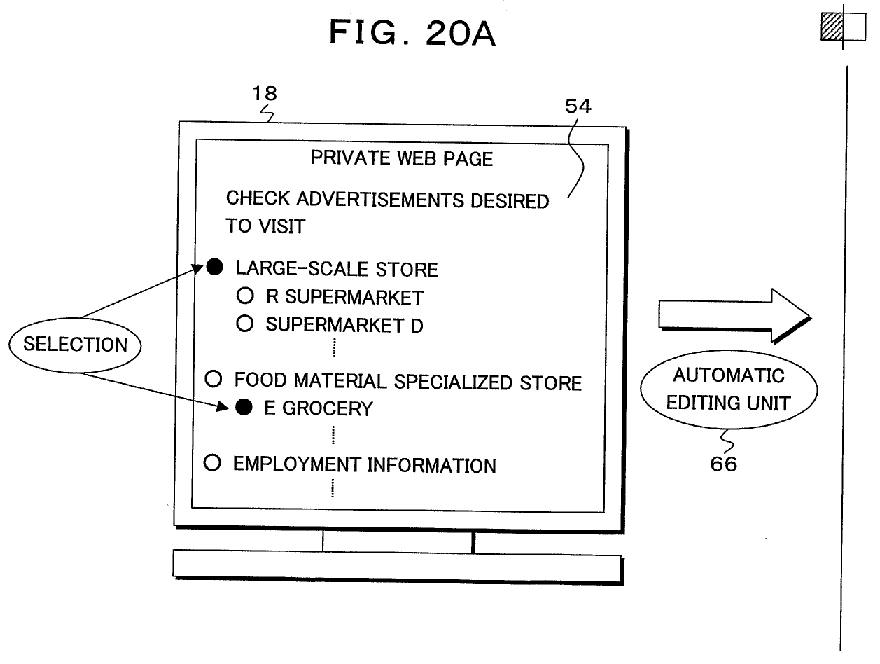

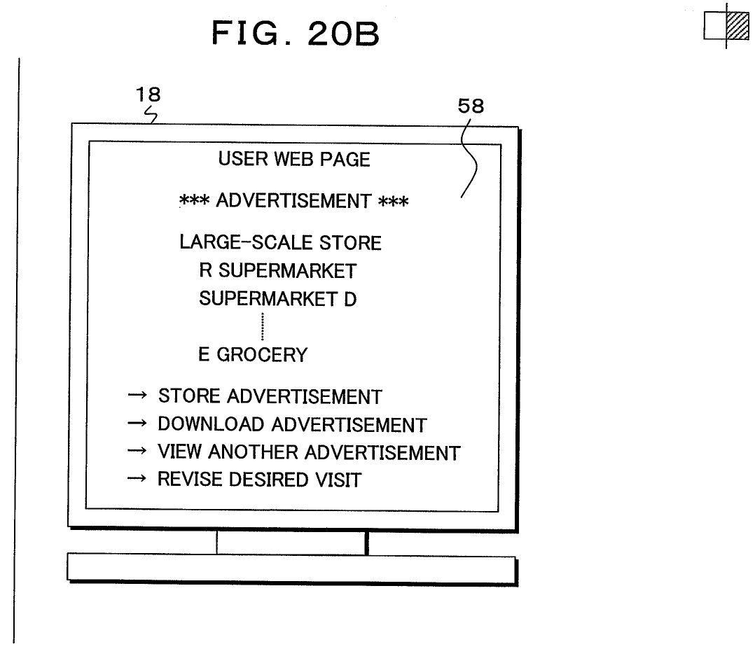

FIGS. 19A and 19B are explanatory drawings that show system functions of the automatic editing process of the user private Web page. An automatic editing unit 66 is installed in the newspaper dealer server 10. Upon receipt of a visiting request to the advertisement Web page 24 by a user client 18, an advertisement menu screen 54, for example, shown in FIG. 20A is displayed. With respect to this advertisement menu screen 54, when the user client selects advertisements, for example, “large-scale store” and “E grocery shop”, the automatic editing unit 66 edits the user private Web page 58, as shown in FIG. 20B, and displays the resulting page. In the examples of FIGS. 19A and 19B, among advertisements 74-1 to 74-n placed in the advertisement Web page 24, four advertisements 74-2, 74-4, 74-5 and 74-6 are selected based upon the user selection information, and these are edited in the automatic editing unit 66, and the resulting advertisements are placed in a user Web page 68 so as to allow the user client 18 to view this. In the case when, after the user private Web page 68 has been prepared through the automatic editing process in this manner, no request for downloading is given from the user client 18 side, the user private Web page 68 thus prepared is stored in the utilization data base 30 together with the user identifying information. In the case when a request for downloading is given from the user client 18 side, the user private Web page 68, automatically edited, is downloaded to the user client 18 so as to be viewed. This downloading process of the user private Web page 68 to the user client 18 is carried out by allowing, for example, a mobile terminal of the user to download the page. With this arrangement, by preliminarily selecting only advertisements of a genre required, the user is allowed to download the user private Web page automatically edited by the newspaper dealer server 10 through the mobile terminal; thus, for example, when the user goes shopping, he or she can view the user private Web page downloaded in the mobile terminal, and use this as a note for selecting advertised commodities.

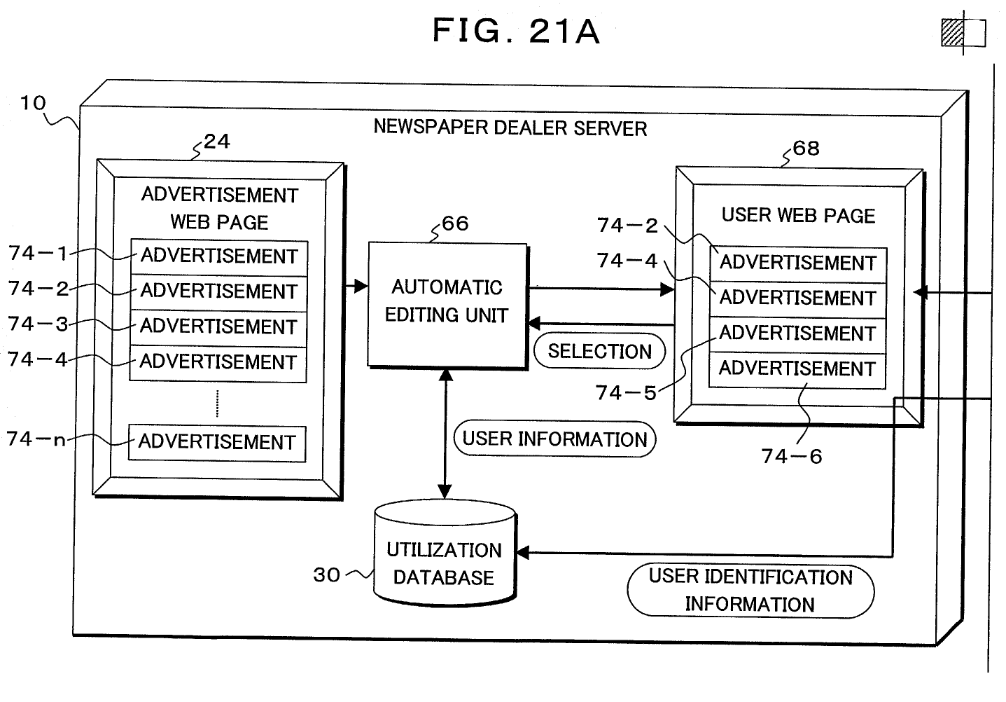

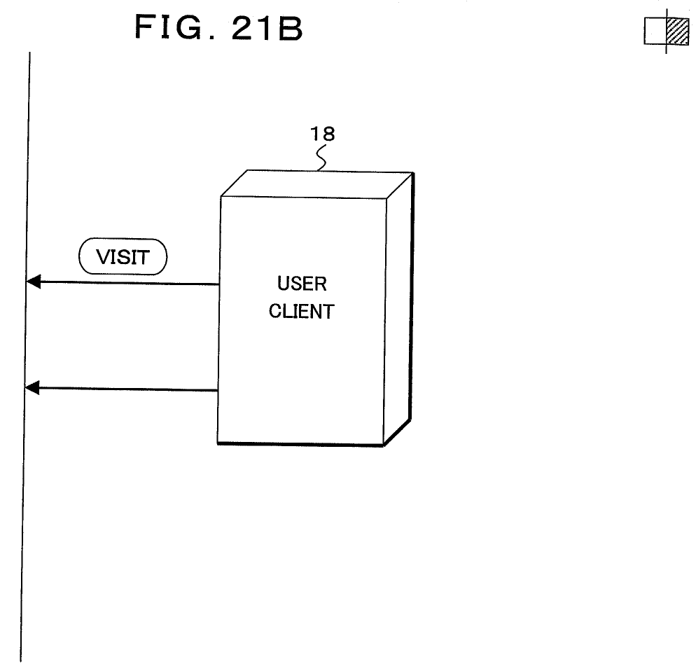

FIGS. 21A and 21B show another embodiments of the automatic editing process of the user private Web page, and this embodiment is characterized in that, instead of storing the Web page automatically edited, advertisement selection information specified by the user is stored at the server side. In other word, the automatic editing unit 66 is installed in the newspaper dealer server 10, and based upon a selection request following the advertisement visiting process from the user client 18, advertisements selected from the advertisement Web page 24 are automatically edited to form a user private Web page 68 so as to be viewed. This point is the same as the embodiments shown in FIGS. 19A and 19B. In contrast, in the embodiments shown in FIGS. 21A and 21B, the user private Web page 68, automatically edited, is neither stored nor downloaded, and the user specified advertisement selection information, used in the automatic editing unit 66, is stored in the utilization data base 30 as the user information. For this reason, in the case when there is an access from the same user client 28 next time, referring to the utilization data base 30 relating to the user identifying information, the advertisement selection information, once stored, is read out, and supplied to the automatic editing unit 66, and the advertisements specified by the advertisement Web page 24 are selected by the automatic editing unit 66, so that the same user Web page 68 is formed by the automatic editing process so as to be viewed. In this case also, by preliminarily selecting only advertisements of a genre required, the user client 18 is allowed to view the user private Web page 68 that has been automatically edited for the user, without the necessity of making the advertisement selection in the next access and thereafter.

(Local Area Information)

Steps S18 and S19 in FIG. 11B are characterized in that in the advertisement preparation unit 22 in the newspaper dealer server 10, local area information other than advertisements, such as bulletin boards, link information and collections of links, are placed in the advertisement Web page 24 so that the advertisement utilization unit 26 publicizes the local area information to not only registered users of the contractor data base 28, but also to non-registered users. Upon finding, for example, a bulletin board visiting request from the user client at step S18, the publication of the local area information is carried out by publicizing the bulletin board at step S19.

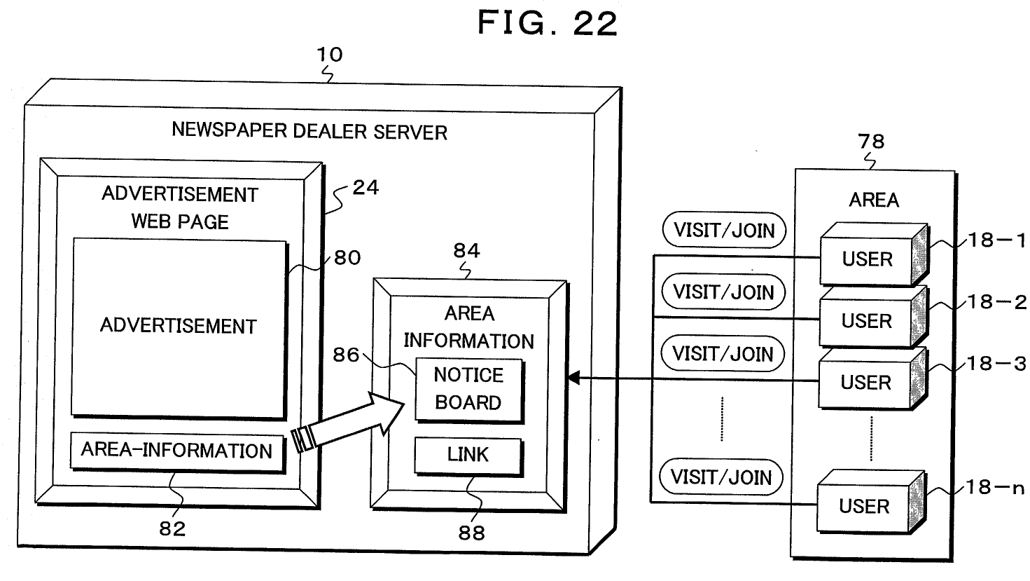

FIG. 22 is an explanatory drawing that shows system functions of the local area information publicizing process. In addition to advertisements 80, local area information 82 is placed in the advertisement Web page 24 of the newspaper dealer server 10. The local area information 82 of the newspaper dealer server 10 is publicized as local area information 84 not only to the contractor users located in the area 78, but also to user clients 18-1 to 18-n that are non-contractors upon receipt of an access therefrom. The local area information 84 includes a bulletin board 86 and a link 88.

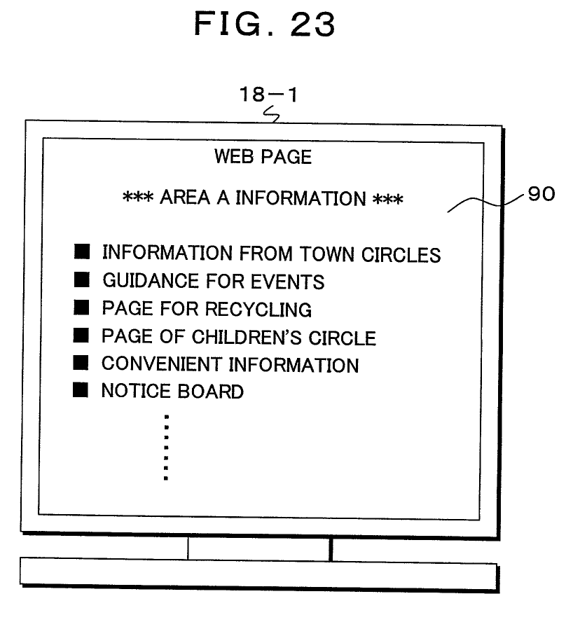

FIG. 23 shows a Web page screen 90 in the user client 18-1 in the area information 84 of FIG. 22, which contains information such as “notice from the town”, “guidance for events”, “page for recycling”, “page for kids' club”, “convenient information” and “bulletin board”. In this manner, by providing a place in which local information is given and the users can exchange information to each other in the Web page of the newspaper dealer server in this manner, it is possible to utilize the system as the information window of the local society, and by publicizing the local information not only to contractor users, but also to non-contractor users, it becomes possible to enhance the advertising effects of the advertising system carried out by the newspaper dealer server 10.

(Preparation for Guide Maps)

Steps S20 to S22 in FIG. 11C are characterized in that in the advertisement utilization unit 26 of the newspaper dealer server 10, a guide map indicating a route from the current position to a destination is formed in response to a request for preparing a guide map including the current position specified by a user to the advertiser, and publicized in an advertisement Web page 24, or downloaded to the user client. In this guide map preparation process, after finding a request for preparation of a guide map from a user client at step S20, the user is allowed to input the current position and a destination of the user at step S21. Then, at step S22, a guide map indicating a route from the current position to the destination is prepared, and places this in the advertisement Web page, thereby allowing the user to view the map.

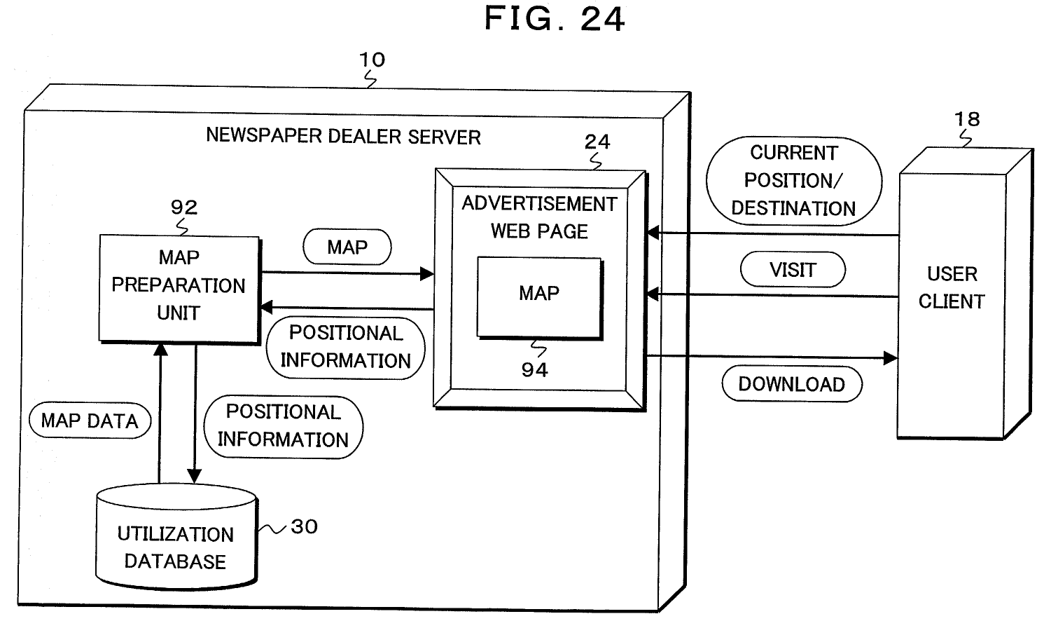

FIG. 24 is an explanatory drawing that shows system functions of the guide map preparation process. A map preparation unit 92 is installed on the newspaper dealer server 10 side. Moreover, map data is preliminarily stored in the utilization data base 30. In the case when, upon viewing the advertisement Web page 24, the user client 18 wants to prepare a guide map, it selects a page for preparation for a guide map from a menu, and inputs positional information of the current position and the destination. Upon receipt of specifications on the current position and the destination by the user, the newspaper dealer server 10 finds positional information by specifying the places on a map or through automatic measurements using GPS based upon address inputs. The positional information thus found is given to the map preparation unit 92, and the map data including the current position and the destination is read by the utilization data base 30 so that a map indicating the current position, the destination and a route is prepared, and publicized as a map 94 on the advertisement Web page 24. The user client 18 downloads the map 94 publicized on the advertisement Web page 24 of the newspaper dealer server 10, and utilizes the map 94.

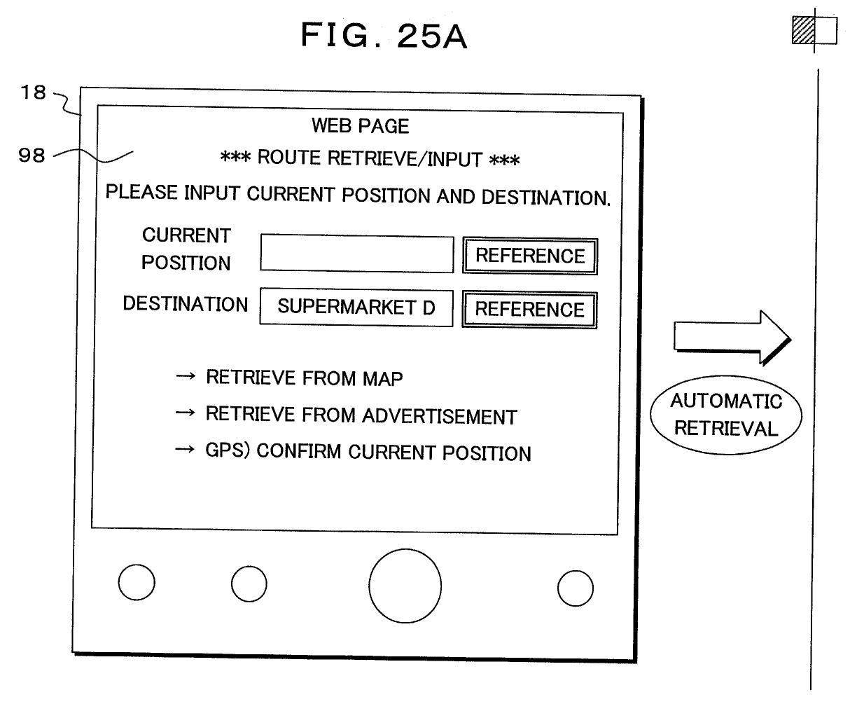

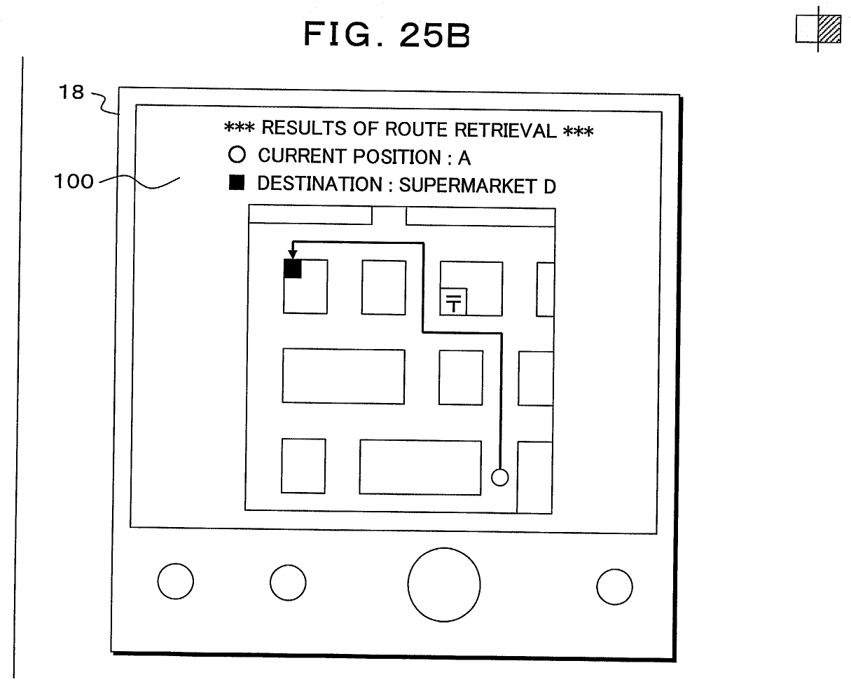

FIG. 25A shows a route-retrieving/inputting screen 98 of the user client 18 in the guide map preparation process where positional information of the user is inputted as the current position and, for example, “supermarket D” that is an advertiser that the user has viewed is inputted as the destination. With respect to the input of the current position, as illustrated on the lower side of the screen, either one of “retrieve from the map”, “retrieve from the advertisement” and “confirmation of the current position (GPS)” is selected, and the reference button is operated. Upon receipt of these current position and destination, an automatic retrieving device 96 of the newspaper dealer server 10 prepares a guide map so that the guide map 100, shown in FIG. 25B, is displayed on the screen of the user client 18. The guide map 100 displays the route from the current position of the user to the destination “supermarket D”. In this manner, since the guide map indicating the newspaper dealer server 10 side to the advertiser is prepared and displayed for the user, the user is allowed to confirm the destination and go there easily, even when he or she does not know the advertiser. Moreover, this arrangement makes it possible to reduce the number of inquiries from users who want to know how to get thereto, and consequently to reduce time-consuming tasks for guidance of the advertiser.

(Ordering Commodities)

Steps S23 and S24 of FIG. 11C are characterized in that an ordering request for advertised commodities from a user is transmitted to the advertiser computer 14 as ordering information in the advertisement utilization unit 26 of the newspaper dealer server 10 so that, after the transmission of the ordering information, the delivery of the ordered commodity to the receipt thereof by the user can be properly managed. In other words, upon finding an order for an advertised commodity from the user at step S23, the ordering process for the ordered commodity to the advertiser server is carried out at step S24, and after the ordering process, the delivery of the ordered commodity to the receipt thereof by the user can be properly managed.

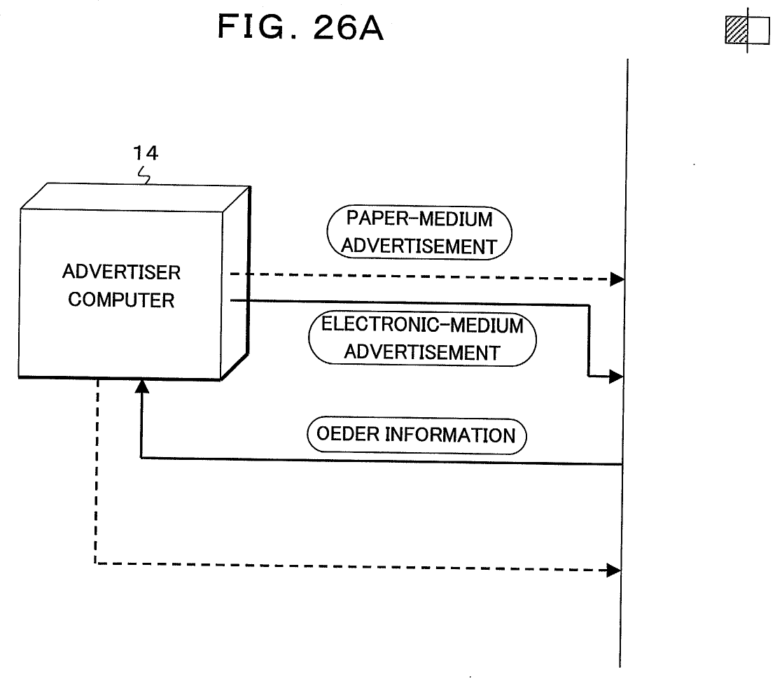

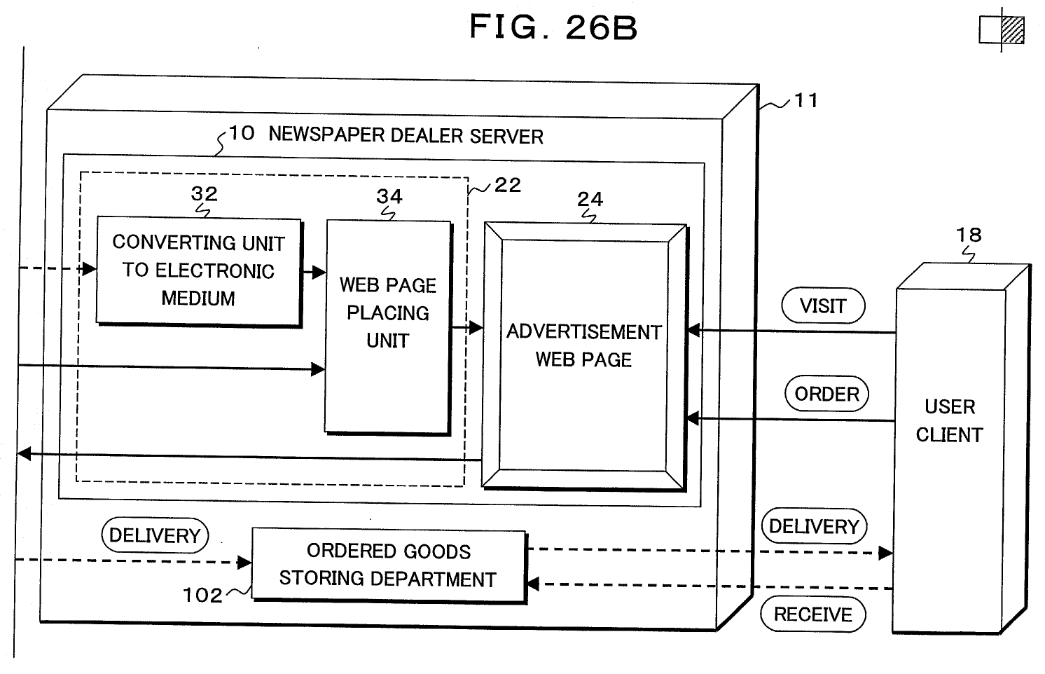

FIGS. 26A and 26B are explanatory drawings that show system functions related to an ordered commodity. In the case when a user orders a commodity viewed in an advertisement placed in an advertisement Web page of the newspaper dealer server 10 from the user client 18, order information based upon the order of this commodity is transferred to the advertiser computer 14 located outside. Upon receipt of the order information from the newspaper dealer server 10, the advertiser computer 14 delivers the ordered commodity to an ordered goods storing department 102 of the newspaper dealer, and thereafter, the commodity is delivered from the ordered goods storing department 102 to the user, who issues a receipt. Such delivering and receiving processes by the ordered goods storing department 102 are managed by the newspaper dealer server 10. With respect to the delivery of the ordered commodity by the ordered goods storing department 102, the newspaper dealer delivers the commodity thus stored at the time of delivering the newspaper, or the user directly receives the ordered commodity at the newspaper dealer. This arrangement in which the newspaper dealer server 10 deals with the commodity order to the advertiser made by a user makes it possible to allow the newspaper dealer to start new business, that is, the ordering and delivering business of commodities. Moreover, since the newspaper delivery person is quite familiar with the local area, he or she can positively deliver the ordered commodity sent from the advertiser 14. Here, since the newspaper dealer is located in the area where the user lives, the user can easily go to the newspaper dealer to get the ordered commodity.

(Delivery of Paper-Medium Advertisement)

Steps S25 and S26 of FIG. 11C are characterized in that based upon a request from a user, the advertisement utilization unit 26 of the newspaper dealer server 10 outputs and prints an advertisement placed in the advertisement Web page 24 on paper medium, and delivers it to the user. In other words, upon receipt of a request for sending advertisement paper-medium from a user who is viewing an advertisement Web page at step S25, the specified advertisement is printed and outputted by a printer at step S26, and the resulting prints are delivered.

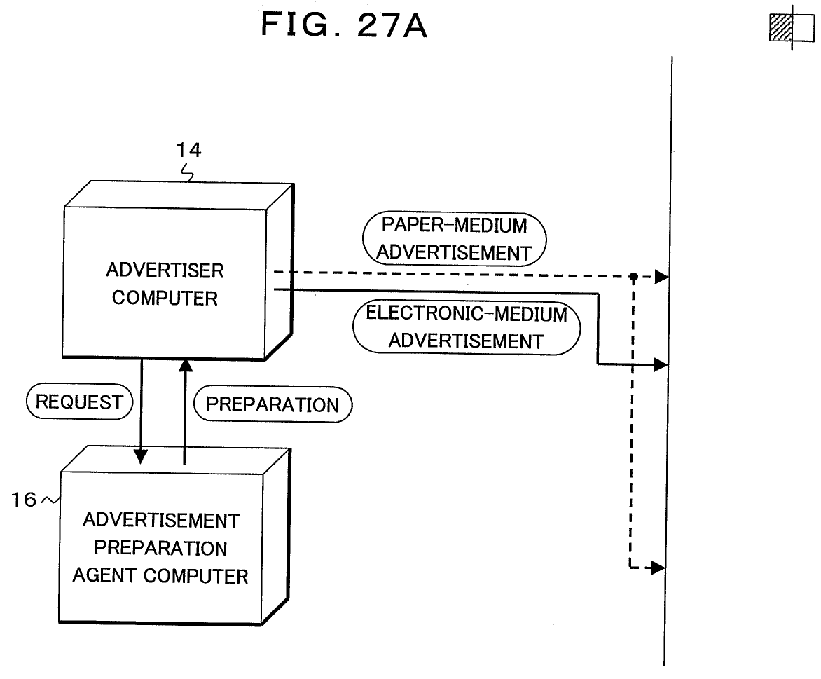

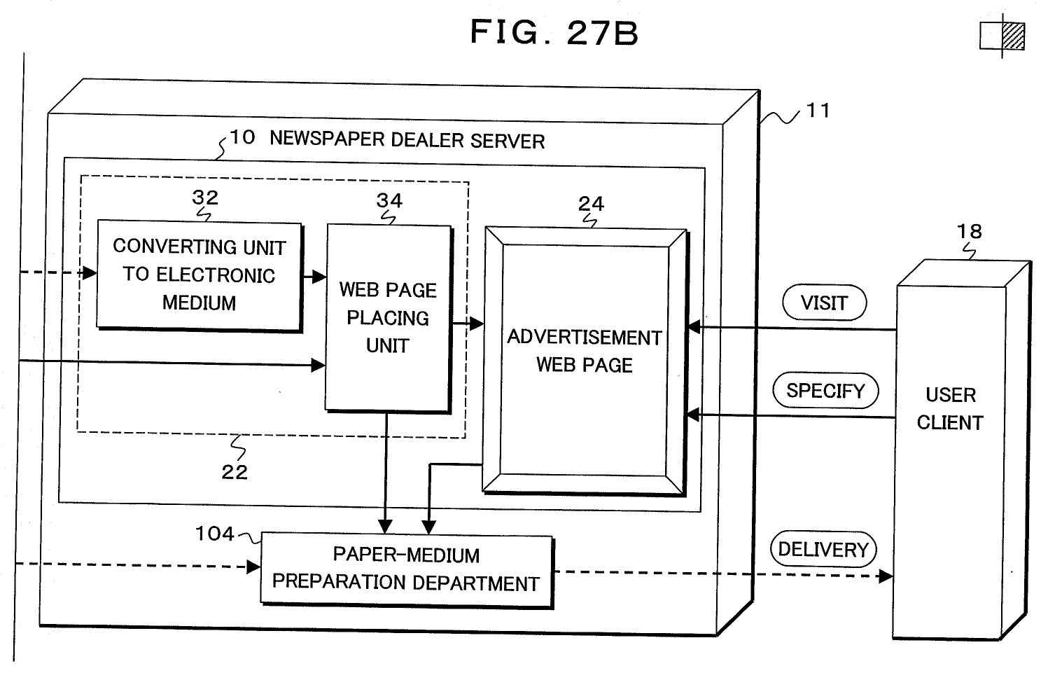

FIGS. 27A and 27B are explanatory drawings that show system functions for delivering the advertisement paper medium. A paper-medium preparation department 104, such as a printer, is placed in the newspaper dealer server 10, and upon receipt of a specification for sending paper medium during a visit to the advertisement Web page 24 through a user client 18, the paper-medium preparation department 104 prints and outputs the specified advertisement of the advertisement Web page 24, and this is inserted in newspapers by a delivery person in the newspaper dealer at the time of delivering the newspaper, and delivered to the user. Moreover, in addition to the paper-medium advertisement printed and outputted from the newspaper dealer server 10, paper-medium advertisements, directly supplied from an advertiser 14, are also inserted into newspapers in the paper-medium preparation department 104, and then delivered to users. In this manner, with respect to an electronic-medium advertisement placed in the advertisement Web page 24 in the newspaper dealer server 10, this is also delivered as paper medium upon request from a user; thus, it is possible to selectively use the delivery of an advertisement through paper medium or electronic medium depending on the necessity, and consequently to allow the user to freely select the utilizing state of advertisements.

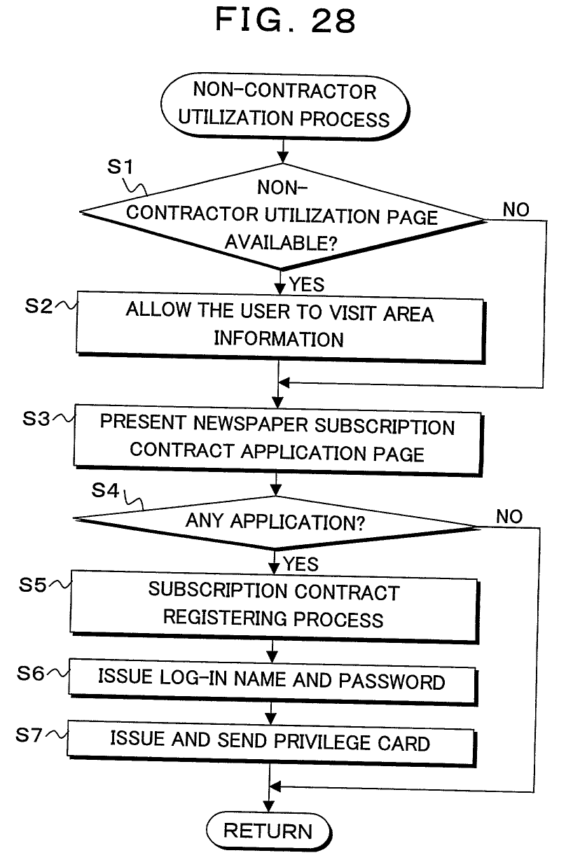

FIG. 28 is a flow chart that shows a non-contractor utilization process in the advertisement utilization process shown in step S6 of FIG. 8, in detail. The advertising system of the present invention is mainly used by contractor users that have subscriber contracts with the newspaper dealer as the subject to the advertising service; however, non-contractor users having no subscriber contracts are also allowed to use the advertisement Web page 24 within a limited range under specific conditions. For this reason, in the non-contractor utilization process, after finding an access from a non-contractor client, a check is made to determine whether or not any non-contractor use page is available at step S1. In this embodiment, local area information, shown in FIG. 24, is prepared as a non-contractor use page; therefore, at step S2, a viewing process for the local area information is carried out. Successively, at step S3, an application page for newspaper subscriber contract, for example, shown in FIG. 29, is presented to the non-contractor user client 18-i as an application page 106. This application page 106 includes an application form for automatic fee settlement and an application form for updating the contract term. Moreover, with respect to non-contractors, an advertisement viewing contract for allowing advertisement visits with charge may be presented to them. Furthermore, a menu concerning information, such as discount ticket information and point exchange information, is displayed as a menu for guidance to privilege services. When a non-contractor applies for a newspaper subscriber contract through this application page 106, the application is detected at step S4, and a registering process to the contractor data base 28 for subscriber contract is carried out at step S5. Successively, at step S6, based upon the contractor registration, a log-in name and a password are issued to the new contractor user as user information used for advertisement visits. Moreover, at step S7, a contractor certification card and contractor certification data used for receiving privileges, such as discount service and point service, are sent, or a data sending process for download is carried out. Here, the application page 106 in FIG. 29 is used not only when a non-contractor applies for newspaper subscriber contract as shown in FIG. 28, but also when a contractor user, who has already registered in the utilization data base 28, tries to apply for automatic payment and to change the contract period in the newspaper subscriber contract.

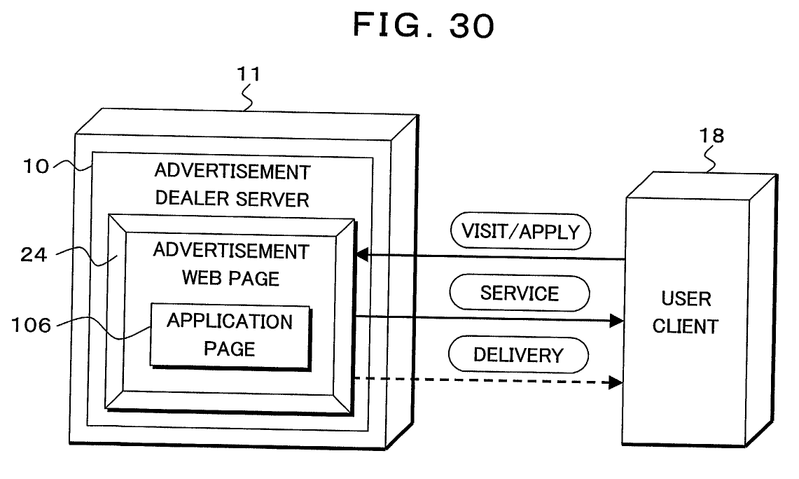

FIG. 30 is an explanatory drawing that shows system functions in the newspaper contract in FIG. 30. Upon receipt of a request for visit from the user client 18 side, the newspaper dealer server 10 publicizes the advertisement Web page 24, and when there is a request for application for subscriber contract from a user client 18, it displays the contract application page 106 from the advertisement Web page 24. Thus, the user is allowed to make a newspaper subscriber contract by using the user client 18. Based upon this, the newspaper dealer delivers the newspaper and supplies necessary services to the user. In this manner, by utilizing the advertisement Web page of the newspaper dealer server 10, processes such as non-contractor's subscriber application, automatic payment or updating of a contractor user, are carried out; therefore, it is possible to reduce the number of visits from the newspaper dealer to users' homes, and consequently to reduce personal expenses. Moreover, in the case of the advertisement visit of a contractor user, for example, when the updating date is drawing close, a message indicating that the contract updating date is close is displayed so that, when visiting the contractor user's home, the person from the newspaper dealer makes it possible to carry out the updating procedure smoothly, since the user is preliminarily aware of the fact that the contract updating data is close.

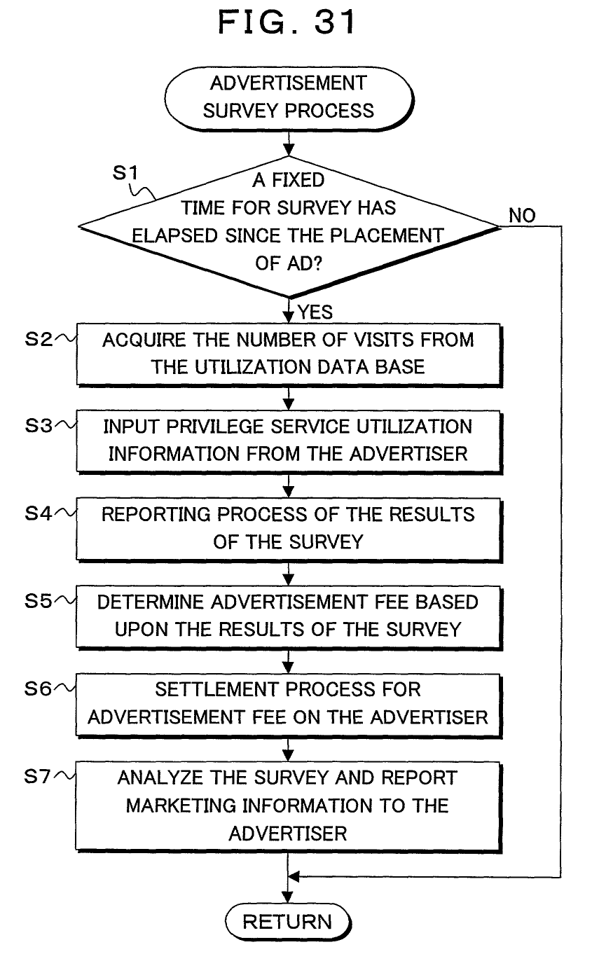

FIG. 31 is a flow chart that shows an advertisement survey process carried out by the newspaper dealer server 10 shown in step S3 of FIG. 5, in detail. In this advertisement survey process, at step S1, a check is made as to whether or not a predetermined period for surveying has elapsed since the placement of an advertisement. If the predetermined advertisement period has elapsed, the number of visits is obtained from the utilization data base 32 at step S2. Moreover, at step S3, the privilege utilization information of the user concerning discount service and point service is inputted from the advertiser computer 14 at step S3. If this privilege utilization information has already been stored in the utilization data base 30, this information is read therefrom. Successively, at step S4, a reporting process for the results of the survey is carried out with respect to the advertiser computer 14. Next, at step S5, an advertising fee is determined based upon the results of the survey. With respect to the determination of the advertising fee, for example, in the case when the number of the advertisement visits exceeds a predetermined number of times, an additional payment of the advertising fee that is given to the newspaper dealer as reward payment is determined based upon an additional fee payment contract. Next, at step S6, settlement processes for bills of the advertising fee to the advertiser are carried out based upon the advertising fee thus determined. Moreover, at step S7, the results of the survey are analyzed, and marketing information, obtained as a result of the analysis, is reported to the advertiser computer 14.

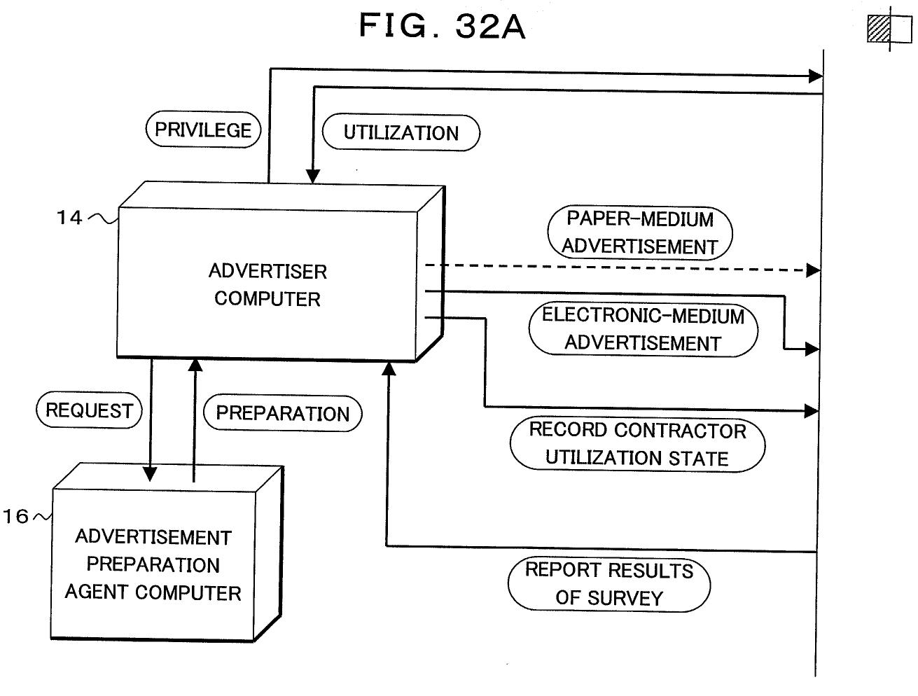

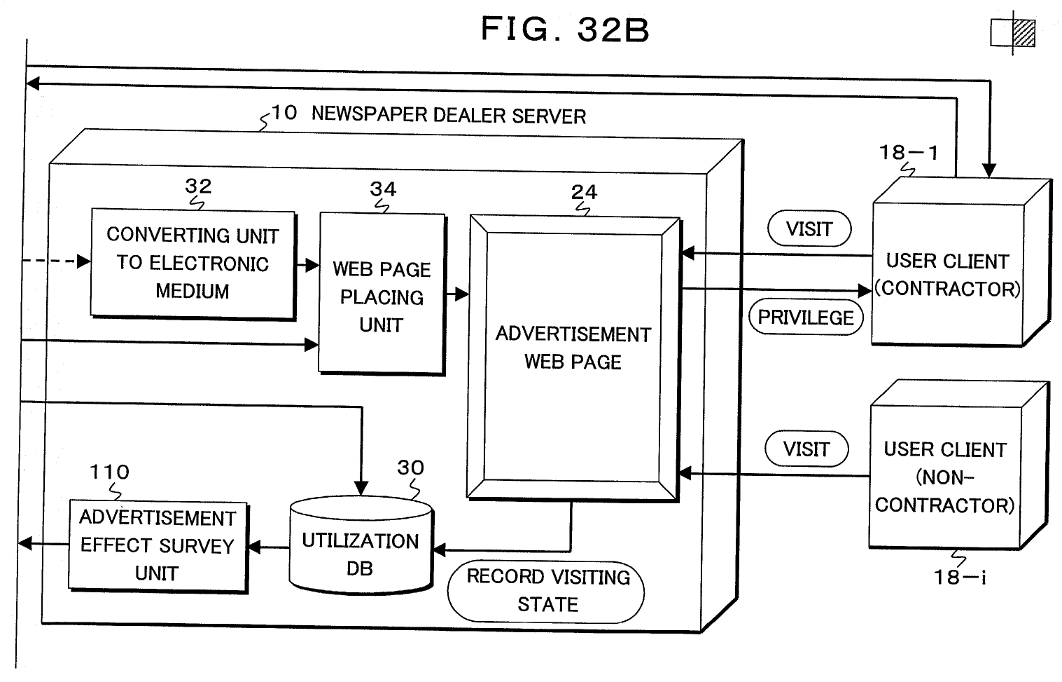

FIGS. 32A and 32B are explanatory drawings that show system functions relating to the advertisement survey process. An advertisement effect survey unit 110 is installed in the newspaper dealer server 10 for this advertisement survey process. Moreover, in the utilization data base 30 of the newspaper dealer server 10, a record of visiting state of the user to the advertisement Web page 24 is preliminarily stored as the number of visits at the time of a visit to the advertisement. Moreover, a contractor utilization state record of discount service and point service used by contractor users is transferred from the advertiser computer 14, and registered in the utilization data base 30. This contractor utilization state record relating to privileges may be transferred at the time of the advertisement survey, or may be preliminarily transferred. With respect to advertisements that are placed for surveying purpose for a predetermined time, the advertisement effect survey unit 110 retrieves the number of placements of those advertisements that have been placed for the predetermined period from the utilization data base 30, and reports the result to the advertiser computer 14. Moreover, the advertisement effect survey unit 110 can analyze the survey results from records related to visiting state and records related to privilege utilization state of contractor users in the utilization data base 30, and supply the resulting marketing information to the advertiser computer 14.

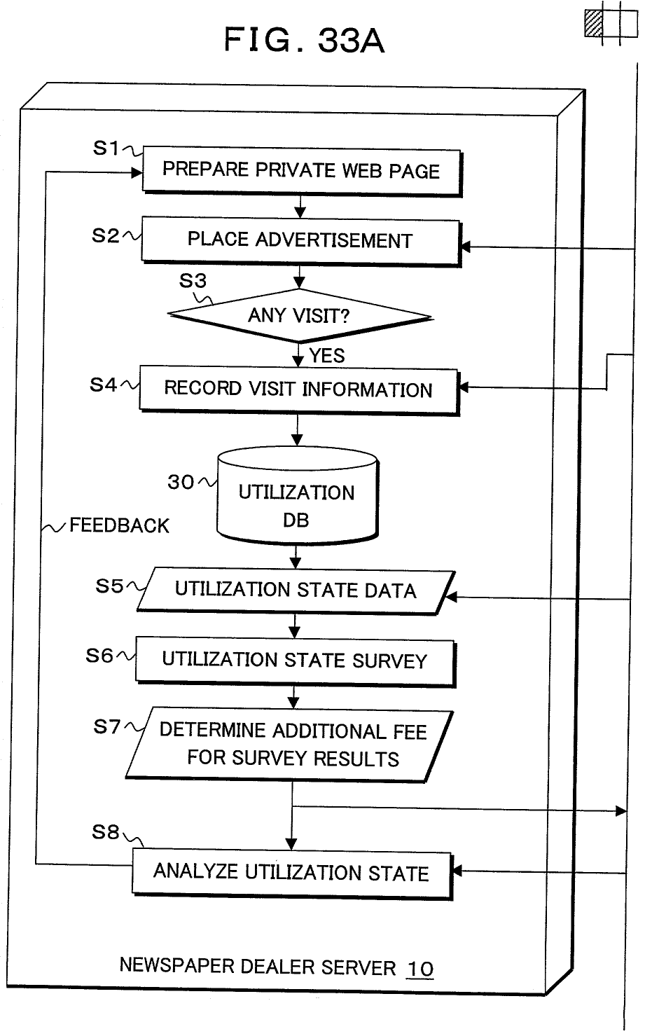

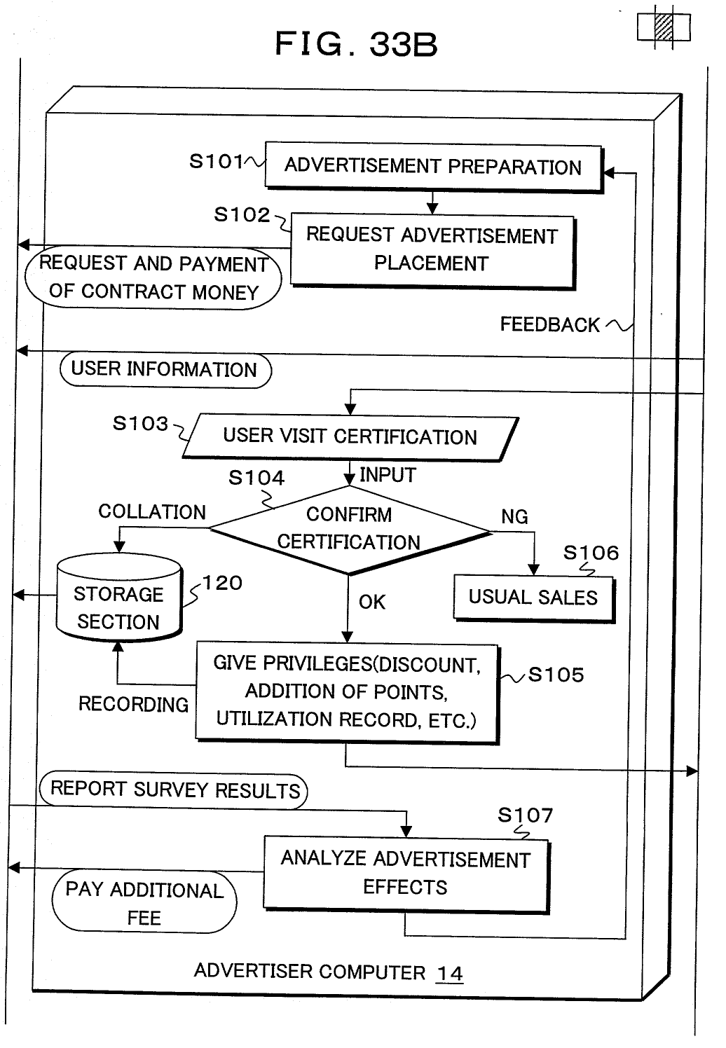

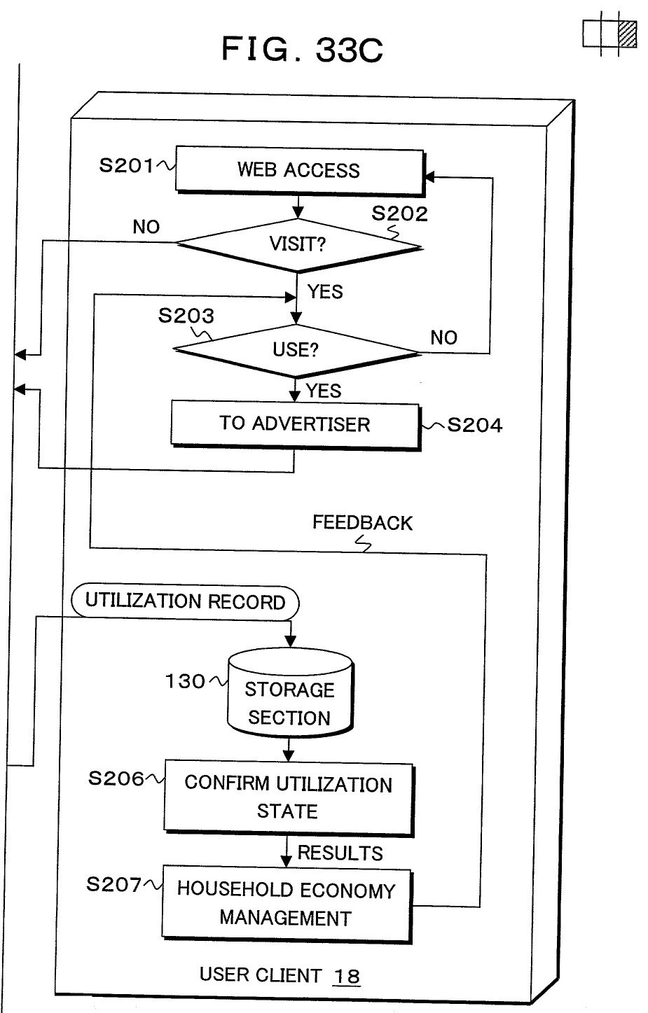

FIGS. 33A to 33C are flow charts that show in detail respective processes in the newspaper dealer server 10, the advertiser computer 14 and the user client 18 in the advertisement survey process. First, as described earlier, the newspaper dealer server 10 prepares an advertisement Web page at step S1, and places the advertisement upon receipt of a request and a payment of contract fee from the advertiser computer 14 at step S2. If there is a visit to the advertisement from a user client 18 at step S3, the visit information is recorded in the utilization data base 30 at step S4. With respect to the advertisement placement at step S2 of the newspaper dealer server 10, an advertisement is prepared at step S101 of the advertiser computer 14, and a request for advertisement placement in the form of an electronic-medium advertisement or a paper-medium advertisement is given to the newspaper dealer server 10 at step S102. Moreover, in the user client 18, an access is made to the advertisement Web page of the newspaper dealer server 10 at step 201, and when an advertisement visit is selected at step 202, a check is made as to whether or not any privilege service is utilized at step S203. In the case when any privilege service is utilized, at step S204, a user visiting certificate is presented to the advertiser by a card or data as information related to the privilege utilization. In the case when a visit is made at step S202, user information related to the visit information record with respect to step S4 of the newspaper dealer server 10 is sent so that the number of visits is recorded in the utilization data base 30 together with the utilization information. With respect to the privilege process in the advertiser computer 14, when a user inputs a user visiting certificate at step S103, this is collated in the storage unit 150 at step S104 to carry out the certificate determination, and if the user is one of the contractor users, privilege processes such as addition of discount points and utilization record are carried out at step S105. If the user is a non-contractor user, normal business practices are carried out without giving any privilege at step S106. In the newspaper dealer server 10, if a predetermined advertisement survey period has been reached, the number of placements is read from the utilization data base 30 at step S5, the privilege user information is received from the storage unit 150 of the advertiser computer 14, and the survey of the utilization state is executed at step S6. Then, at step S7, based upon the results of the survey, determinations concerning, for example, an additional fee, are carried out with respect to the advertiser, and informs the advertiser computer 14 of the results as the report of the survey results. Upon receipt of the survey results from the newspaper dealer server 10, the advertiser computer 14 analyses the advertisement effects at step S107 so that the analysis is fed back to the advertisement preparation at step S101. Moreover, in the case when an additional fee has been determined, the advertiser computer 14 pays the additional fee to the newspaper dealer server 10. The newspaper dealer server 10 analyses the utilization state with respect to the survey results at step S8 so that the analysis is fed back to the preparation of the advertisement Web page at step S1 so as to be reflected to the advertisement. Moreover, the user client 18 stores the utilization record of privileges given at step S105 of the advertiser computer 14 in its storage unit 130. Then, at step S206, the utilization state relating to the privileges is confirmed, if necessary, and this is reflected to a home financial management at S207, and also fed back to the judgment as to whether or not the privileges at step S206 are utilized. In accordance with the advertisement survey process of the advertising system of the present invention, the newspaper dealer surveys the effects of the advertisement placed in the advertisement Web page, and can charge an additional fee to the advertiser based upon the effects of the advertisement. By reflecting the survey results of the advertisement utilization state to the preparation of the advertisement Web page, the newspaper dealer makes it possible to prepare a Web page having higher advertising effects. Moreover, based upon the survey results from the newspaper dealer server 10, the advertiser makes it possible to prepare an advertisement having higher advertising effects and also to carry out marketing practices, such as reformation of business establishment.

As described above, in accordance with the present invention, a newspaper dealer is allowed to establish an advertising system utilizing the Internet by managing an advertising server for advertisers having business with the newspaper dealer and subscribers having the newspapers delivered; therefore, it is possible to positively establish an advertising system of a local area contacting type having specified advertisers and users in a short time.

Moreover, the costs required for managing the advertising server basically depend on advertising fees from the advertisers, while the users who are also subscribers of the newspaper pay for one portion of the costs as subscription fees; thus, it is possible to ensure sufficient managing costs from the advertisers and the users.

Moreover, a delivery area of each newspaper dealer is determined based upon physical distances and time, etc., and even in the case of an advertising system utilizing the Internet, advertisers who request inserted-bill advertisements are limited to the delivery area or on the periphery thereof, while advertisements aiming at larger areas are originally supplied as newspaper advertisements; thus, it is possible to properly inherit the advantages of the conventional inserted-bill advertisements that closely contact to a specific local area, that is, easiness, local property and cheapness of advertising costs.

Moreover, in the present invention, the Web pages on which advertisements are placed are only viewed by the contractor users who are registered in the data base of the newspaper dealer, on principle, and only the users who are also subscribers of the newspaper are allowed to view the advertisements placed by the server of the newspaper dealer; this results in a discriminated state to non-subscribers of the newspaper. This discriminated state makes it possible to increase new subscribers of the newspaper.

The advertisement utilization of the present invention includes not only visits to advertisements placed, but also various types of services including privilege offering systems to users, such as discount service and point service, delivery of advertisements through mail and facsimile upon request from users, linking service to the advertiser, wider linking service to other newspaper dealer servers, preparation of a private advertisement page upon advertisement selection request from a user and related storage and download, an automatic editing process of an advertisement Web page through the storage of the advertisement selection information, visit to local area information aiming at contractor users as well as non-contractor users, preparation for a guide map, ordering commodities and delivery of paper-medium advertisements; thus, it is possible to establish an advertising service of a local area contacting type by utilizing the Internet, which would not be expected from the conventional inserted-bill advertisement. Moreover, in the newspaper dealers, it is possible to reduce the conventionally required sorting and inserting jobs for paper-medium advertisements, and consequently to reduce costs by cutting personal expenses and labor expenses. Accordingly, it is also possible to cut costs and labor on the side of the advertiser.

Moreover, in the present invention, the advertisement effects are confirmed by carrying out an advertisement survey, and by reflecting the results of the survey to the advertisement effects in the newspaper dealer and the advertiser, it is possible to realize an advertisement preparation and an advertisement placement that are more effective. Moreover, by obtaining the utilization state of discount service and point service with respect to an advertiser, the user is allowed to improve the home financial management and utilize the data as a source of judgments to the next advertisement utilization.

Here, the above-mentioned embodiment has exemplified an advertising system utilizing newspaper dealers; however, the present invention is not intended to be limited by this, and also applied to a circumstance in which an existing organization preliminarily has contracts with users with respect to services and commodities. Moreover, others who are skilled in the applicable arts will recognize numerous modifications and adaptations of the illustrated embodiments which will remain within the principles of the present invention.

What is claimed is:

1. An advertising server characterized by comprising:
a data base which registers a supplier for providing a first service and users that have contracts with the supplier;
an advertisement preparation unit for preparing an advertisement requested by an advertiser and for placing said advertisement on a Web page so as to be viewed, that is, for providing a second service; and
an advertisement utilization unit which, in the case when a user is identified as a contractor user of the first service on the data base through the inputted user information, allows the user to view said advertisement on the Web page so as to provide the second service.

2. An advertising server characterized by comprising:
at least, a contractor data base that registers contractors that have subscriber contracts with the newspaper dealer;
an advertisement preparation unit for preparing an advertisement requested by an advertiser and for placing said advertisement on a Web page so as to be viewed; and
an advertisement utilization unit which, in the case when a user is identified as a contractor user on the data base through the inputted user information, allows the user to view said advertisement on the Web page.

3. The advertising server according to claim 1, characterized in that said advertisement preparation unit inputs an electronic medium advertisement from an advertiser and places the resulting advertisement on said Web page, and also converts a medium advertisement from an advertiser to electronic data, and places the resulting advertisement on said Web page.

4. The advertising server according to claim 1, characterized in that said advertisement preparation unit prepares an advertisement requested by an advertiser or a Web page of the advertiser.

5. The advertising server according to claim 1, characterized in that, when a user views said advertisement on the Web page, said advertisement utilization unit gives a privilege offered by a newspaper dealer or an advertiser to the user viewing said advertisement.

6. The advertising server according to claim 1, characterized in that said advertisement utilization unit stores advertisement selection information specified and desired by a user, and delivers an advertisement corresponding to the corresponding advertisement selection information by mail or facsimile.

7. The advertising server according to claim 1, characterized in that, based upon a linking request specified by a user, said advertisement utilization unit makes a link to the publicized Web page of the advertiser.

8. The advertising server according to claim 1, characterized in that, based upon a linking request specified by a user, said advertisement utilization unit makes an access to a Web page of the advertiser managed by a newspaper dealer on the same chain in a different area.

9. The advertising server according to claim 1, characterized in that said advertisement utilization unit automatically edits a Web page dedicated to a user based upon advertisement selection information specified by the user, and stores the resulting data, or downloads the data to the user device.

10. The advertising server according to claim 1, characterized in that said advertisement utilization unit stores advertisement selection information specified by a user, and upon receiving a visiting request from the user, automatically edits a Web page dedicated to the user based upon said advertisement selection information thus stored, and allows to user to visit the page.

11. The advertising server according to claim 1, characterized in that said advertisement preparation unit places local information other than advertisements, such as bulletin boards and link collections on said Web page, and said advertisement utilization unit publicizes local information to contractor users and non-contract users of said data base.

12. The advertising server according to claim 1, characterized in that upon receipt of a visiting request from a non-contract user not registered in the data base, said advertisement utilization unit presents an application page for newspaper subscriber contract.

13. The advertising server according to claim 1, characterized in that said advertisement utilization unit retrieves contractor users who need to update the contract from the data base, and displays the necessity of updating the contract at the time of visiting said Web page.

14. The advertising server according to claim 1, characterized in that based upon a request for preparation of a guide map including the current position specified by a user and the destination indicating the advertiser, said advertisement utilization unit prepares the guide map indicating a route from the current position to the destination, and publicizes the guide map in said Web page, or downloads it to the user device.

15. The advertising server according to claim 1, characterized in that said advertisement utilization unit transmits an ordering request for an advertised commodity from a user to the advertiser's device as ordering information, and after the transmission, manages processes from delivery to receipt of the ordered commodity.

16. The advertising server according to claim 1, characterized in that based upon the request from the user, said advertisement utilization unit prints an advertisement placed on said Web page on paper media, and distributes the resulting advertisement.

17. The advertising server according to claim 1, characterized in that said advertisement utilization unit registers visiting information of the user for each advertisement visit, surveys the advertisement utilization state by retrieving said data base after a lapse of a predetermined period from the publish of the advertisement, and informs the advertiser's device of the results of the survey, and determines and settles an advertisement publishing fee based upon the results of the survey.

18. An advertising method using a server characterized by comprising:
a registering step of registering in a data base a supplier for supplying a first service and users having contracts with the supplier;
an advertisement preparation step of preparing an advertisement requested from the advertiser and of placing the advertisement in a Web page to allow it to be viewed, which is a second service;
an advertisement utilization step in which, in the case when a user is identified as a contractor user of said first service on the data base through the inputted user information, the user is allowed to view the advertisement on said Web page so as to provide said second service.

19. A program characterized by allowing a computer functioning as a server to execute:
a registering step of registering in a data a supplier for supplying a first service and users having contracts with the supplier;
an advertisement preparation step of preparing an advertisement requested from the advertiser and of placing the advertisement in a Web page so as to be viewed, which is a second service; and
an advertisement utilization step in which, in the case when a user is identified as a contractor user of said first service on the data base through the inputted user information, the user is allowed to view the advertisement on said Web page so as to provide said second service.

20. A program characterized by allowing a computer functioning as a server of a newspaper dealer to execute:
a registering step of registering at least contractors having subscriber contracts with a newspaper dealer in a data base;
an advertisement preparation step of preparing an advertisement requested by an advertiser and of placing it in a Web page; and
an advertisement utilization step in which, in the case when a user is identified as a contractor on the data base through the inputted user information, the user is allowed to view the advertisement on said Web page.

21. A recording medium that is read by a computer and that stores a program, characterized by allowing a computer functioning as a server to execute:
a registering step of registering in a data base a supplier for supplying a first service and users having contracts with the supplier;
an advertisement preparation step of preparing an advertisement requested from the advertiser and of placing the advertisement in a Web page to allow it to be viewed, which is a second service; and
an advertisement utilization step in which, in the case when a user is identified as a contractor user of said first service on the data base through the inputted user information, the user is allowed to view the advertisement on said Web page so as to provide said second service.

22. A recording medium that is read by a computer and that stores a program, characterized by allowing a computer functioning as a server of a newspaper dealer to execute:
a registering step of registering at least contractors having subscriber contracts with a newspaper dealer in a data base;
an advertisement preparation step of preparing an advertisement requested by an advertiser and of placing the advertisement in a Web page; and
an advertisement utilization step in which, in the case when a user is identified as a contractor on the data base through the inputted user information, the user is allowed to view the advertisement on said Web page.
